(19) United States
(12) Patent Application Publication
(10) Pub. No.: US 2010/0284333 A1
(43) Pub. Date: Nov. 11, 2010

(54) METHOD AND APPARATUS FOR DATA SESSION SUSPEND CONTROL IN A WIRELESS COMMUNICATION SYSTEM

(75) Inventors: Masakazu Shirota, Tokyo (JP); Reza Shahidi, San Diego, CA (US); Thomas Klingenbrunn, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/773,300

(22) Filed: May 4, 2010

Related U.S. Application Data
(60) Provisional application No. 61/176,795, filed on May 8, 2009.

(51) Int. Cl. H04W 92/02

(52) U.S. Cl. 370/328; 370/357

(57) ABSTRACT

Systems and methodologies are described herein that facilitate data session suspend control in a multi-radio wireless communication system based on user equipment capability. As described herein, various techniques are provided herein whereby a wireless communication network with which a user device communicates can suspend a data session and/or other communication session associated with the user device upon identifying that the user device has moved to a disparate communication network based on the transmitter/receiver capabilities of the user device. In one example herein, a mobility management entity and/or other network management entity can determine whether to perform suspend control based on an event notification from another network based on user capability. In another example herein, a network to which a user device moves can determine whether to send an event notification to another network associated with the user device based on capabilities of the user device.

### CROSS-REFERENCE

This application claims the benefit of U.S. Provisional Application Ser. No. 61/176,795, filed May 8, 2009, and entitled “DATA SESSION SUSPEND CONTROL BASED ON USER EQUIPMENT CAPABILITY,” the entirety of which is incorporated herein by reference.

### BACKGROUND

I. Field

The present disclosure relates generally to wireless communications, and more specifically to techniques for managing communication sessions in a wireless communication environment.

II. Background

Wireless communication systems are widely deployed to provide various communication services; for instance, voice, video, packet data, broadcast, and messaging services can be provided via such wireless communication systems. These systems can be multiple-access systems that are capable of supporting communication for multiple terminals by sharing available system resources. Examples of such multiple-access systems include Code Division Multiple Access (CDMA) systems, Time Division Multiple Access (TDMA) systems, Frequency Division Multiple Access (FDMA) systems, and Orthogonal Frequency Division Multiple Access (OFDMA) systems.

A wireless multiple-access communication system may simultaneously support communication for multiple wireless terminals. In such a system, each terminal can communicate with one or more base stations via transmissions on the forward and reverse links. The forward link (or downlink) refers to the communication link from the base stations to the terminals, and the reverse link (or uplink) refers to the communication link from the terminals to the base stations. This communication link can be established via a single-input-single-output (SISO), multiple-input-single-output (MISO), single-input multiple-output (SIMO), or a multiple-input-multiple-output (MIMO) system.

Interworking between different radio access technologies (RATs) can be utilized to provide substantially continuous communication service for a mobile device in a multi-radio communication system. For example, interworking between respective RATs can be utilized to facilitate data session continuity, voice call continuity, fallback to circuit switched (CS) service, or the like, even in a case where a mobile terminal or other device moves between different RATs. However, in the event that a mobile device and/or one or more systems with which a mobile device is associated do not support various services or other functionality, one or more communication services associated with the mobile device can be partially continued. Accordingly, it would be desirable to implement techniques for managing communication sessions associated with a mobile device in a multi-radio wireless environment.

### SUMMARY

The following presents a simplified summary of various aspects of the claimed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed aspects in a simplified form as a prelude to the more detailed description that is presented later.

According to an aspect, a method is described herein. The method can comprise identifying an associated user equipment unit (UE) and a data session corresponding to the associated UE; receiving at least one transmitter (Tx)/receiver (Rx) capability parameter relating to the associated UE; obtaining notification signaling from one or more network entities; and determining whether to suspend the data session corresponding to the associated UE in response to the notification signaling based at least in part on the at least one Tx/Rx capability parameter.

A second aspect described herein relates to a wireless communications apparatus, which can comprise a memory that stores data relating to an associated UE, a data session corresponding to the associated UE, and at least one Tx/Rx capability parameter relating to the associated UE. The wireless communications apparatus can further comprise a processor configured to obtain notification signaling from one or more network entities and to determine whether to suspend the data session corresponding to the associated UE in response to the notification signaling based at least in part on the at least one Tx/Rx capability parameter.

A third aspect relates to an apparatus, which can comprise means for identifying a UE and a data session corresponding to the UE; means for receiving at least one Tx/Rx capability parameter relating to the UE; and means for determining whether to suspend the data session corresponding to the UE in response to an event notification received from one or more network entities based at least in part on the at least one Tx/Rx parameter.

A fourth aspect described herein relates to a computer program product, which can include a computer-readable medium that comprises code for causing a computer to identify a UE and a data session corresponding to the UE; code for causing a computer to receive at least one Tx/Rx capability parameter relating to the UE; and code for causing a computer to determine whether to suspend the data session corresponding to the UE in response to an event notification received from one or more network entities based at least in part on the at least one Tx/Rx parameter.

According to a fifth aspect, a method is described herein. The method can comprise obtaining information relating to Tx/Rx capability of an associated UE; receiving signaling relating to a connection event from the associated UE; and determining whether to provide a notification of the connection event to one or more network entities based at least in part on the Tx/Rx capability of the associated UE.

A sixth aspect described herein relates to a wireless communications apparatus, which can comprise a memory that stores data relating to information indicative of Tx/Rx capability of an associated UE. The wireless communications apparatus can further comprise a processor configured to receive signaling relating to a connection event from the associated UE and to determine whether to provide a notification of the connection event to one or more network entities based at least in part on the Tx/Rx capability of the associated UE.

A seventh aspect relates to an apparatus, which can comprise means for obtaining information relating to Tx/Rx capability of a UE; means for receiving signaling relating to a connection event from the UE; and means for determining whether to provide an event notification for the connection event to one or more network entities based at least in part on the Tx/Rx capability of the UE.

An eighth aspect described herein relates to a computer program product, which can include a computer-readable medium that comprises code for causing a computer to obtain information relating Tx/Rx capability of a UE; code for causing a computer to receive signaling relating to a connection event from the UE; and code for causing a computer to determine whether to provide an event notification for the connection event to one or more network entities based at least in part on the Tx/Rx capability of the UE.

According to a ninth aspect, a method is described herein. The method can comprise identifying at least a first communication network and a second communication network from which communication service is received; determining one or more parameters relating to Tx/Rx capability with respect to the first communication network and the second communication network; and conveying signaling relating to a circuit switched (CS) voice call that includes the one or more parameters relating to Tx/Rx capability to an entity associated with at least one of the first communication network or the second communication network.

A tenth aspect described herein relates to a wireless communications apparatus, which can comprise a memory that stores data relating to at least a first communication network and a second communication network from which communication service is received. The wireless communications apparatus can further comprise a processor configured to determine one or more parameters relating to Tx/Rx capability with respect to the first communication network and the second communication network and to convey signaling relating to a CS voice call that includes the one or more parameters relating to Tx/Rx capability to an entity associated with at least one of the first communication network or the second communication network.

An eleventh aspect relates to an apparatus, which can comprise means for determining at least one parameter relating to Tx/Rx capability with respect to a plurality of communication networks and means for conveying signaling relating to a CS voice call that includes the at least one parameter relating to Tx/Rx capability to an entity associated with at least one communication network in the plurality of communication networks.

A twelfth aspect described herein relates to a computer program product, which can include a computer-readable medium that comprises code for causing a computer to determine at least one parameter relating to Tx/Rx capability with respect to a plurality of communication networks and code for causing a computer to convey signaling relating to a CS voice call that includes the at least one parameter relating to Tx/Rx capability to an entity associated with at least one communication network in the plurality of communication networks.

To the accomplishment of the foregoing and related ends, one or more aspects of the claimed subject matter comprise the features hereinafter fully described and particularly pointed out in the claims. The following description and the annexed drawings set forth in detail certain illustrative aspects of the claimed subject matter. These aspects are indicative, however, of but a few of the various ways in which the principles of the claimed subject matter can be employed. Further, the disclosed aspects are intended to include all such aspects and their equivalents.

### BRIEF DESCRIPTION OF THE DRAWINGS

FIG. 1 is a block diagram of a system that facilitates user capability-dependent communication session management in a wireless communication system.

FIG. 2 illustrates an example call flow for mobile termination in connection with a circuit-switched fallback (CSFB) procedure in accordance with various aspects.

FIG. 3 illustrates an example data session suspend control procedure that can be utilized in accordance with various aspects described herein.

FIG. 4 is a block diagram of a system for performing data session suspension based on determined user capabilities in accordance with various aspects.

FIG. 5 illustrates another example data session suspend control procedure that can be utilized in accordance with various aspects described herein.

FIGS. 6-7 are block diagrams of respective systems for providing notification signaling for data session suspension based on determined user capabilities in accordance with various aspects.

FIGS. 8-12 are flow diagrams that illustrate respective methodologies that facilitate data session suspend control in a wireless communication environment based on user equipment (UE) capability.

FIG. 13 is a flow diagram of a methodology that facilitates capability reporting with respect to communication sessions conducted within a wireless communication system.

FIGS. 14-16 are block diagrams of respective apparatuses that facilitate data session management in a wireless communication environment.

FIG. 17 illustrates a wireless multiple-access communication system in accordance with various aspects set forth herein.

FIG. 18 is a block diagram illustrating an example wireless communication system in which various aspects described herein can function.

### DETAILED DESCRIPTION

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

As used in this application, the terms “component,” “module,” “system,” and the like are intended to refer to a computer-related entity, either hardware, firmware, a combination of hardware and software, software, or software in execution.

For example, a component can be, but is not limited to being, a process running on a processor, an integrated circuit, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a wireless terminal and/or a base station. A wireless terminal can refer to a device providing voice and/or data connectivity to a user. A wireless terminal can be connected to a computing device such as a laptop computer or desktop computer, or it can be a self contained device such as a personal digital assistant (PDA). A wireless terminal can also be called a system, a subscriber unit, a subscriber station, mobile station, mobile, remote station, access point, remote terminal, access terminal, user terminal, user agent, user device, or user equipment (UE). A wireless terminal can be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. A base station (e.g., access point or Node B) can refer to a device in an access network that communicates over the air-interface, through one or more sectors, with wireless terminals. The base station can act as a router between the wireless terminal and the rest of the access network, which can include an Internet Protocol (IP) network, by converting received air-interface frames to IP packets. The base station also coordinates management of attributes for the air interface.

Moreover, various functions described herein can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc (BD), where disks usually reproduce data magnetically and discs reproduce data optically with lasers. Combinations of the above should also be included within the scope of computer-readable media.

Various techniques described herein can be used for various wireless communication systems, such as Code Division Multiple Access (CDMA) systems, Time Division Multiple Access (TDMA) systems, Frequency Division Multiple Access (FDMA) systems, Orthogonal Frequency Division Multiple Access (OFDMA) systems, Single Carrier FDMA (SC-FDMA) systems, and other such systems. The terms “system” and “network” are often used herein interchangeably. A CDMA system can implement a radio technology such as Universal Terrestrial Radio Access (UTRA), CDMA2000, etc. UTRA includes Wideband-CDMA (W-CDMA) and other variants of CDMA. Additionally, CDMA2000 covers the IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is an upcoming release that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Further, CDMA2000 and UMB are described in documents from an organization named “3rd Generation Partnership Project 2” (3GPP2).

Various aspects will be presented in terms of systems that can include a number of devices, components, modules, and the like. It is to be understood and appreciated that the various systems can include additional devices, components, modules, etc. and/or omit some or all of the devices, components, modules etc. discussed in connection with the figures. A combination of these approaches can also be used.

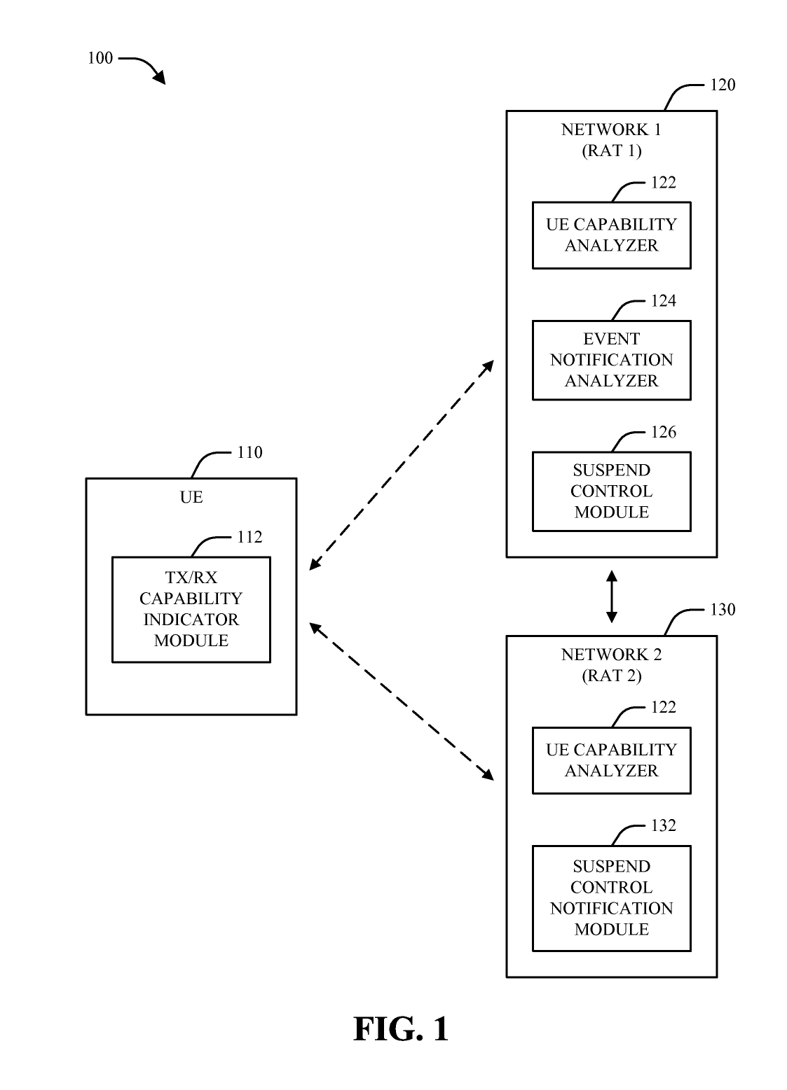

Referring now to the drawings, FIG. 1 illustrates a system 100 that facilitates user capability-dependent communication session management in a wireless communication system in accordance with various aspects described herein. As FIG. 1 illustrates, system 100 can include one or more user equipment units (UEs) 110 (also referred to herein as mobile devices or stations, terminals, access terminals (ATs), etc.), which can communicate with one or more networks 120-130. In one example, respective networks 120-130 can operate according to various radio access technologies (RATs), such as, for example, 3GPP LTE, CDMA2000 (e.g., 1x Radio Transmission Technology (RTT), etc.), WiMax, WLAN, UMTS, or the like. Further, respective networks 120-130 in system 100 can include and/or otherwise be associated with one or more network entities, such as base stations (e.g., Node Bs or Evolved Node Bs (eNBs), cells or network cells, access points (APs), network nodes, etc.), interworking systems and/or other entities that facilitate communication between respective networks 120-130, network controllers, and/or other suitable network entities. Various specific examples of network entities that can be employed for respective networks 120-130 of various RATs are provided in further detail herein.

With respect to the following discussion, it should be appreciated that while various examples are provided for the specific, non-limiting example of LTE/1x interworking, the various aspects provided herein can be utilized to facilitate communication session management and RAT interworking for any suitable RAT(s) and/or combination(s) thereof. For example, various techniques as utilized herein can be utilized in the context of 3GPP (e.g., LTE) systems, cdma2000 (e.g., 1x) systems, UMTS systems, WiFi or WiMax systems, WLAN systems, Bluetooth systems, and/or any other suitable system(s) operating according to any appropriate RAT(s). Further, unless explicitly stated otherwise, it is to be appreciated that the claimed subject matter recited herein is not intended to be limited to any specific RAT(s) and/or entities associated therewith.

In accordance with one aspect, UE 110 can engage in one or more uplink (UL, also referred to herein as reverse link (RL)) communications with networks 120-130, and similarly networks 120-130 can engage in one or more downlink (DL, also referred to herein as forward link (FL)) communications to UE 110. In one example, UL and/or DL communication between UE 110 and networks 120 and/or 130 can correspond to any suitable communication session and/or type. Examples of communication sessions that can be conducted between UE 110 and networks 120-130 include, but are not limited to, voice sessions, data sessions, multimedia (e.g., audio, video, etc.) sessions, Short Message Service (SMS) sessions, or the like.

In accordance with another aspect, networks 120-130 operating according to different RATs can utilize one or more techniques for interworking with each other. For example, interworking techniques between RATs can be utilized to provide data session continuity, voice call continuity, fallback to circuit service, and/or other functionalities to facilitate continuity of service for a given UE 110 even if the UE 110 moves between different RATs. However, in some particular cases, a target system (e.g., to which UE 110 moves) may not support all functionalities that are supported by a source system (e.g., from which a UE 110 moves away in order to utilize the target system). In such a case, it can be appreciated that services can be partially continued.

In one example, in the context of an interworking solution between an LTE system (e.g., utilizing an Evolved UMTS (Universal Mobile Telecommunications System) Terrestrial Radio Access Network (E-UTRAN), an Evolved Packet Core (EPC), etc.) and a cdma2000 1x system, UE 110 can support varying degrees of transmitter (Tx)/receiver (Rx) capability. For example, in a first scenario (herein referred to as “case 1”), UE 110 can monitor one RAT at a time. In a second scenario (herein referred to as “case 2”), UE 110 can enable protocol stacks and/or other means associated with respectively associated RATs (e.g., an E-UTRAN/EPC and/or a cdma2000 network, etc.) substantially simultaneously and can monitor substantially all RATs at the same time such that if a communication (e.g., a voice call, a data call, etc.) is to be performed, an appropriate RAT is chosen to enable UE 110 to begin communication with the chosen RAT. In a third scenario (herein referred to as “case 3”), UE 110 can be capable of transmission and reception of signals from multiple RATs simultaneously. In the specific example case where two RATs (e.g., associated with an E-UTRAN/EPC and a cdma2000 network) are considered, the functionality associated with case 3 is referred to herein as “dual Tx/Rx” functionality. In one example, various aspects described herein with respect to case 3 can also be applied to a scenario wherein UE 110 is capable of transmission and reception of signals from multiple RATs simultaneously but monitors only one RAT at a time.

In accordance with one aspect, UE 110 can utilize various Tx/Rx configurations and/or other means corresponding to the cases above to facilitate varying levels of communication with respective networks 120-130 in system 100. Thus, for example, in case 1 as described above, UE 110 be configured to transmit signals to, receive signals from, and/or otherwise utilize one RAT at a time. Alternatively, in case 2 as described above, UE 110 can be equipped with dual receivers and/or other mechanisms to enable UE 110 to monitor two or more RATs at the same time. However, as noted above, a UE 110 operating according to case 2 may be equipped with only a single transmitter and/or other means for transmitting signals to only a single RAT at a time. As another alternative, in case 3 as described above, a UE 110 can utilize dual receivers and transmitters and/or other means to enable full dual Tx/Rx functionality to two or more RATs simultaneously.

For case 1 and case 2 as described above, it can be appreciated that one or more network entities (e.g., an EPC at a network 120-130 operating according to LTE, etc.) can be required to perform suspend control when UE 110 is on traffic in another network (e.g., a 1x network, etc.), as a data session corresponding to UE 110 is substantially incapable of being handed off to the other network. In accordance with one aspect, suspend control as performed in system 100 can include sending a suspend request message to a serving gateway (S-GW) and/or other suitable means and/or deciding which message(s) to forward to UE 110. However, it can be appreciated that triggers for suspend control within system 100 can differ between case 1 and case 2 as described above.

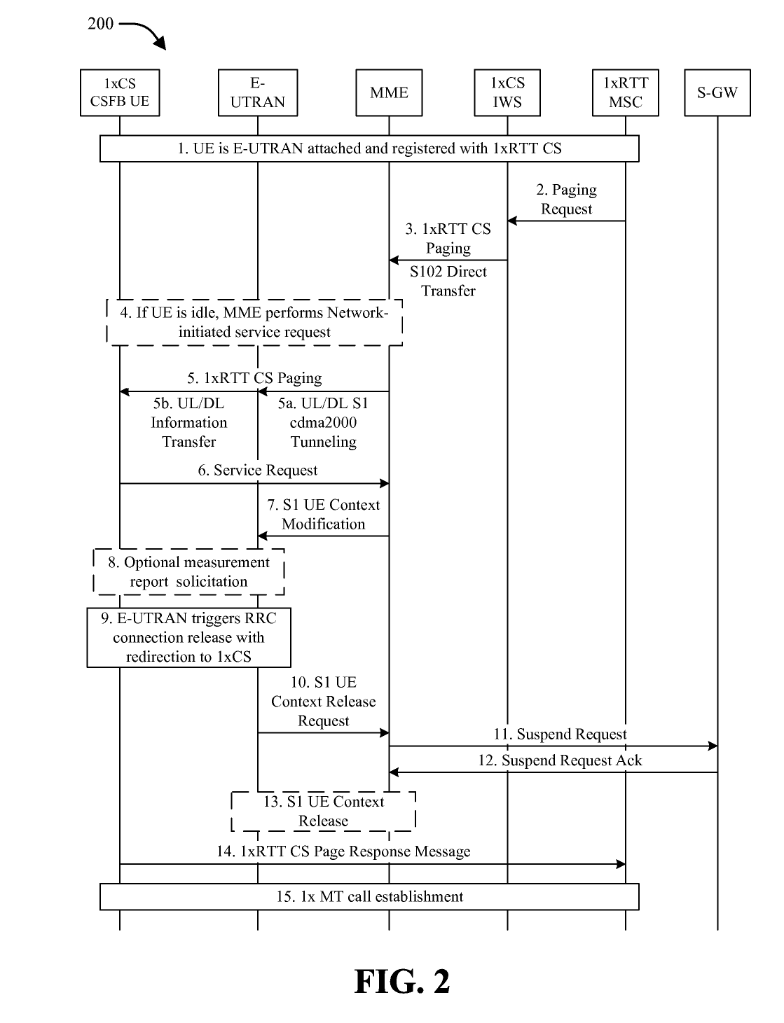

In the specific, non-limiting scenario of a UE 110 operating according to case 1 for a 1x network and an LTE network, suspend control can be triggered when UE 110 accesses the 1x network via circuit-switched fallback (CSFB) procedures and/or other suitable means. For example, interworking between a UE, an LTE network including an E-UTRAN and a mobility management entity (MME), a 1x network including a 1xCS interworking system (IWS) and a 1xRTT mobile switching center (MSC), and a S-GW can be performed as shown by flow diagram 200 in FIG. 2 to facilitate mobile termination in a 1x CSFB procedure. For example, as shown by flow diagram 200, a UE can initially perform an attachment procedure and/or other suitable procedures with an E-UTRAN associated with a LTE network. Additionally, the UE can be registered with a 1xRTT network. In one example as shown by flow diagram 200, a UE can be camped on the LTE network for a given period of time, upon which a paging message can be provided to the UE from the LTE network. The paging message can, for example, originate at a MSC associated with the 1x network (e.g., at step 2 in flow diagram 200) and be relayed to the LTE network for transfer to the UE via an IWS associated with the 1x network (e.g., as shown by step 3). In one example, a S102 interface and/or other suitable means between the LTE and 1x networks can be utilized to transfer the paging message at step 3. Upon receiving the paging message, the LTE network can set up a traffic channel at step 4 and provide the paging message to the UE as shown at step 5. In one example, a S1 interface and/or other suitable means can be utilized for transferring the paging message from the LTE network to the UE at step 5.

Upon receiving the paging message from the 1x network at step 5, the UE can subsequently perform a CSFB procedure as shown by steps 6-9 in order to obtain the necessary information for communication over the 1x network. In one example, upon completion of step 9, the UE can move to the 1x network (e.g., to continue an associated voice call, etc.). Accordingly, if communication between the UE and the E-UTRAN is released, the E-UTRAN can communicate with the MME as shown at step 10 such that the MME sends the S-GW a suspend request at step 11. In accordance with one aspect, the suspend request communicated at step 11 can instruct the S-GW to act such that, while the UE is communicating with the 1x network, the S-GW abstains from sending data to the LTE network via the E-UTRAN and/or any other suitable entities within the LTE network.

In summary, as shown by flow diagram 200, suspend control can be performed by a wireless communication network upon occurrence of a CSFB procedure. Subsequently, if the UE returns to the network that initiated suspend control, the corresponding data session can be resumed. However, returning to system 100, it can be appreciated that initialization of data session suspend controls may not be necessary depending on capabilities of UE 110. Thus, for example, while suspend control can be performed as shown by flow diagram 200 in the example of case 1 as described above, it can be appreciated that case 2 may only require suspend control to be performed in the case where UE 110 is on traffic on another network. Further, it can be appreciated that suspend controls can in some cases be omitted for a UE 110 operating according to case 3 as described above. Thus, in accordance with one aspect, a network 120 as provided herein can implement one or more techniques for performing suspend control based on the capabilities of UE 110.

In accordance with one aspect as described herein, UE 110 can utilize a Tx/Rx capability indicator module 112 and/or other suitable means to indicate its capabilities with respect to monitoring, transmission, and/or one or more other aspects of communication with networks 120-130. In one example, UE 110 can identify at least a first communication network (e.g., network 120) and a second communication network (e.g., network 130) from which communication service is received and determine one or more parameters relating to Tx/Rx capability with respect to the first communication network and the second communication network. Based on these determined capabilities, UE 110 can utilize Tx/Rx capability indicator module 112 or the like to convey signaling relating to a CS voice call and/or any other suitable communication session. Such signaling can include, for example, one or more determined parameters relating to Tx/Rx capacity. In one example, Tx/Rx capability indicator module 112 can convey such signaling to an entity associated with at least one of the first communication network or the second communication network. Entities to which Tx/Rx capability indicator module 112 can provide signaling include, but are not limited to, an E-UTRAN associated with at least one of network 120 or network 130, a home location register (HLR) associated with at least one of network 120 or network 130, a MSC associated with at least one of network 120 or network 130, and/or any other suitable entity or combination thereof.

In accordance with another aspect, one or more networks 120-130 can utilize signaling relating to Tx/Rx capability of UE 110 to facilitate management of data sessions and/or other communication sessions associated with UE 110. As illustrated in FIG. 1, network 120 can operate to suspend a data session associated with UE 110 in various cases as described herein in the event that UE 110 is associated with network 130. However, it can be appreciated that the various components of networks 120-130, as well as the various aspects described herein, can be distributed between any suitable network(s) 120 and/or 130 in any appropriate manner.

As shown in system 100 and in accordance with one aspect described herein, network 120 can identify an associated UE 110 and a data session corresponding to the associated UE 110. In addition, network 120 can utilize a UE capability analyzer 122 and/or other suitable means to receive at least one Tx/Rx capability parameter relating to the associated UE 110. Additionally or alternatively, network 120 can utilize an event notification analyzer 124 and/or other suitable means to obtain notification signaling from one or more network entities (e.g., an interworking system and/or any other suitable entities from which a notification can be received) associated with network 130. Based on information received by network 120, a suspend control module 126 and/or other suitable mechanisms can then be utilized to determine whether to suspend the data session corresponding to the associated UE 110 in response to notification signaling received by event notification analyzer 124 based at least in part on at least one Tx/Rx capability parameter received by UE capability analyzer 122.

As further shown in system 100 and in accordance with another aspect described herein, network 130 can utilize a UE capability analyzer 122 and/or other means to obtain information relating to Tx/Rx capability of an associated UE 110 in a similar manner to network 120. Further, network 130 can receive signaling relating to a connection event from the associated UE 110, based on which a suspend control notification module 132 and/or other components of network 130 can determine whether to provide a notification of the connection event to one or more network entities (e.g., a network interworking entity that facilitates communication to network 120, at which the notification can be processed by an event notification analyzer 124 as described above) based at least in part on the Tx/Rx capability of the associated UE 110 as determined by UE capability analyzer 122.

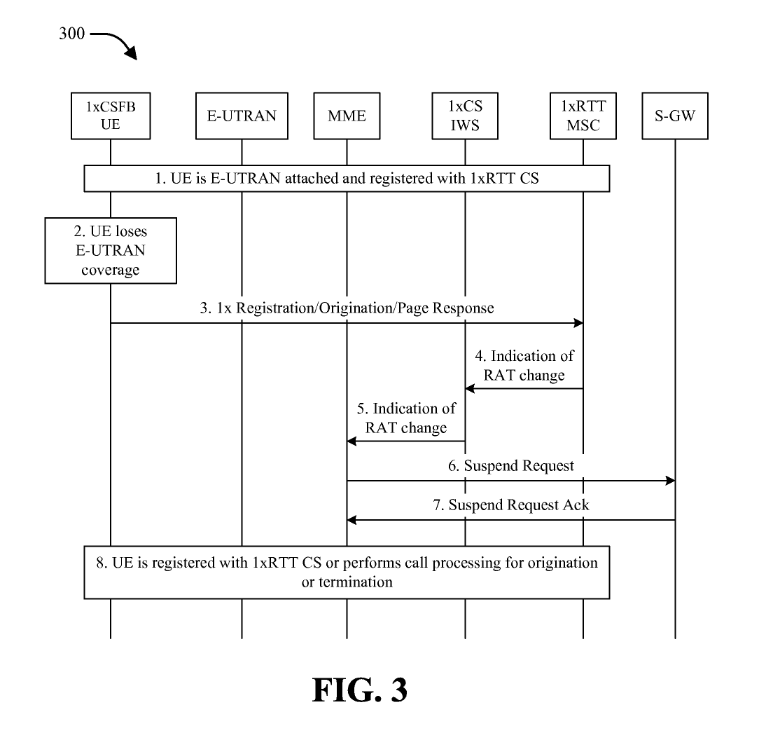

In accordance with a further aspect, various techniques that can be performed as described herein to facilitate data session suspend control in a wireless communication system can in some cases operate according to the example call flow shown by flow diagram 300 in FIG. 3. While various aspects described herein can utilize the control mechanisms illustrated in flow diagram 300 as an example scenario in which the respective aspects can operate, it should be appreciated that the techniques described herein can be utilized in the context of any suitable use case(s). Further, while flow diagram 300 illustrates a specific example involving 1x/LTE interworking, it should be appreciated that the techniques described and illustrated herein can be utilized to facilitate communication session control for any suitable RAT(s) and/or other communication system types.

In general, it can be appreciated that flow diagram 300 illustrates an example procedure for data session suspend control by a first RAT (e.g., LTE) from another RAT (e.g., cdma2000 1x). As shown by flow diagram 300, the procedure can begin at step 1, wherein the UE is E-UTRAN attached and registered with 1xRTT CS. Next, as shown at step 2, the UE may in some cases lose E-UTRAN coverage. Accordingly, if the UE is configured to tune to 1xRTT when it loses E-UTRAN coverage, the UE can perform 1x registration at step 3 after performing 1x system acquisition. In another scenario, if the UE had lost E-UTRAN coverage when it was about to originate a CS call, the UE can perform an origination at step 3. In yet other scenario, if the UE had received a 1x page message while it was in E-UTRAN, but it lost E-UTRAN coverage before sending the Service Request, the UE can send a 1x page response at step 3. In one example, the UE can also indicate at step 3 that it registered through a different RAT.

Next, at step 4, if the 1x MSC receives a registration, origination or page response from the UE (e.g., as sent at step 3) via the 1x network, it can notify an associated IWS at step 4 that the UE has moved to 1x. A message provided to the IWS at step for can be an indication of RAT change as shown in flow diagram 300, or more generally the message can indicate that the UE is active on 1x. At step 5, the IWS can then inform the MME that the UE has moved to another system (with or without identifying that the other system is a 1x system). In one example, step 5 can be conducted by relaying the message received in step 4 and/or by converting the message into a format understandable by the LTE system. In one example, the specific manner in which a message is provided to the MME at step 5 can depend on the protocols that are utilized for the interfaces between the MME and the IWS as well as between the IWS and the MSC.

At step 6, if the MME has not received the service request indicating the handoff to 1x, it can set the UE context to a suspended status and provide a Suspend Request to an associated S-GW to request the suspension of Evolved Packet System (EPS) bearers for the UE. At step 7, the S-GW can then acknowledge the Suspend Request message and mark the UE as suspended. Finally, as shown at step 8, the UE is registered with 1xRTT CS and/or performs call processing for origination or termination.

Thus, as described above and illustrated by flow diagram 300, a UE can initially camp on a E-UTRAN network and/or one or more other components of a LTE network. Next, in the case that the UE loses E-UTRAN coverage, the UE can send registration, origination, or page response signaling to an associated 1x network based on settings that have been configured for the UE. Based on such signaling, a MSC at the 1x network can obtain information from the UE, a HLR related to the UE, and/or other suitable network entities regarding whether the UE is interworking capable, whether the UE has registered through the E-UTRAN, and/or other suitable information. Subsequently, based on some or all of the obtained information, the MSC can indicate to an IWS that the UE has moved to the 1x network, and the IWS can in turn forward the indication to an MME at the LTE network. Accordingly, the MME can determine that the UE previously registered with the E-UTRAN and, in the case that the UE is not dual Tx/Rx capable, send a suspend request to the S-GW and receive a corresponding acknowledgement.

In accordance with one aspect, the indications as shown at steps 4 and 5 of flow diagram 300 can be optional in some cases. Further, the indications as shown in steps 4 and 5 can be performed in a variety of different manners. For example, the indications can be performed using a paging procedure (e.g., in a similar manner to that shown by flow diagram 200) and/or any other suitable over the air procedure(s). In accordance with another aspect, an indication that the UE has lost coverage from the E-UTRAN can be provided via the MSC at steps 4-5, as it can be appreciated that communication over the E-UTRAN in such a case may be impractical or impossible. In accordance with a further aspect, whether an indication is provided at steps 4-5, and/or whether a suspend control procedure is conducted as shown at steps 6-7, can be based on capabilities of the UE as determined and/or utilized in various manners. Various examples of techniques that can be utilized to perform suspend control based on UE capabilities are described below.

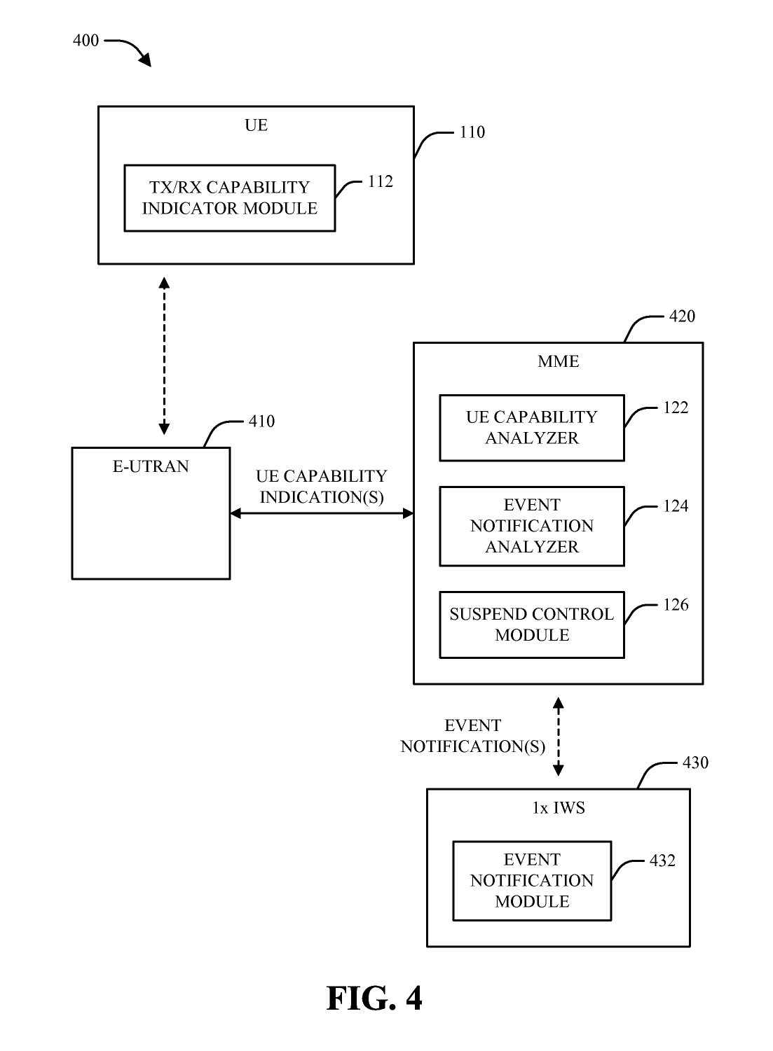

Turning next to FIG. 4, a system 400 for performing data session suspension based on determined user capabilities in accordance with various aspects is illustrated. As shown in FIG. 4, system 400 can include a UE 110, which can communicate with an LTE network that includes an E-UTRAN 410 and a MME 420, a 1x network that includes an IWS 430, and/or any other suitable network(s). In accordance with one aspect, UE 110 and/or E-UTRAN 410 can be configured such that UE 110 can convey its Tx/Rx capability to E-UTRAN 410 and/or one or more other elements of an LTE network (e.g., via a Tx/Rx capability indicator module 112). A Tx/Rx capability indication can be provided by UE 110 upon registration with E-UTRAN 410 and/or at any other suitable time(s). Accordingly, in one example, MME can receive at least one Tx/Rx capability parameter relating to UE 110 from an E-UTRAN 410 providing communication service to UE 110 in various manners. The Tx/Rx capability parameters can indicate, for example, which type of interworking capability (e.g., case 1, case 2, and/or case 3 as described above, etc.) that is supported by UE 110.

As system 400 additionally illustrates, an event notification module 432 can be configured to always send an Event Notification and/or other notification signaling to MME 420. In one example, notification signaling can relate to a CSFB procedure performed by UE 110 and/or any other suitable events performed within system 400. For example, in the event that IWS 430 is associated with a 1xRTT system, notification signaling obtained by MME 420 can relate to access of UE 110 to the 1xRTT system via a CSFB procedure. A CSFB procedure can be performed by UE 110 in response to a mobile originated (MO) voice call to the 1xRTT system over a tunnel provided by E-UTRAN 410 and/or any other suitable triggering event(s). Specific examples of procedures that can be utilized to perform suspend control based on a MO voice call are provided in further detail herein. Additionally or alternatively, MME 420 can be operable to obtain notification signaling indicative of any other suitable event(s), such as movement of UE 110 to coverage of a network corresponding to IWS 430 and/or another suitable network entity or the like.

In accordance with one aspect, based on the capabilities of UE 110 (e.g., as analyzed by a UE capability analyzer 122), MME 420 can perform suspend control when it receives an Event Notification and/or other notification signaling. For example, if at least one Tx/Rx capability parameter obtained by MME 420 indicates that UE 110 monitors one RAT at a time (e.g., case 1), MME 420 can perform suspend control and/or otherwise suspend a data session corresponding to UE 110 (e.g., via a suspend control module 126) upon receiving an Event Notification and/or obtaining any other suitable notification signaling. In another example, if at least one Tx/Rx capability parameter obtained by MME 420 indicates that UE 110 monitors two or more RATs simultaneously and transmits over one RAT at a time (e.g., case 2), MME 420 can perform suspend control and/or otherwise suspend a data session corresponding to UE 110 upon obtaining an Event Notification and/or other notification signaling that indicates that UE 110 is on traffic in a network associated with IWS 430 and/or another suitable network entity (e.g., as identified by an event notification analyzer 124). In a further example, if at least one Tx/Rx capability parameter obtained by MME 420 indicates that UE 110 transmits and receives on two or more RATs simultaneously (e.g., case 3) or that UE 110 transmits and receives on two or more RATs simultaneously and monitors one RAT at a time, MME 420 can elect (e.g., via suspend control module 126) not to perform suspend control and/or otherwise suspend a data session corresponding to UE 110 even upon obtaining an Event Notification and/or other notification signaling. In accordance with one aspect, upon determining that a data session corresponding to UE 110 is to be suspended, a data session suspend request can be signaled to an associated serving gateway (not shown) in accordance with various aspects as described and illustrated herein.

In accordance with another aspect, in the event that UE 110 supports dual Tx/Rx operation, system 400 can perform such that UE 110 is not required to work in two or more domains (e.g., corresponding to multiple RATs) at a time; instead, UE 110 can operate within system 400 by monitoring only E-UTRAN 410. Accordingly, when a communication trigger, such as an incoming call and related paging request, occurs, UE 110 can undergo a 1x CSFB procedure and operate as generally illustrated by flow diagram 200 in FIG. 2. However, if MME 420 is able to determine that UE 110 has dual Tx/Rx capability and is also 1x capable, MME 420 can elect not to perform suspend control (e.g., as shown by step 11 in flow diagram 200) even if the UE context is released (e.g., as shown by step 10 in flow diagram 200). As an alternative to the procedure shown in flow diagram 200, it can be appreciated that in the case of call origination, the Service Request messaging shown at step 6 of flow diagram 200 can occur without some or all of the paging indicated in the preceding steps.

In general, it can be appreciated that Tx/Rx capability of UE 110 can be indicated to MME 420 through E-UTRAN 410 (which can obtain information relating to the capability of UE 110 directly from UE 110 via, for example, Tx/Rx capability indicator module 112). Subsequently, MME 420 can decide whether UE 110 is a simultaneous Tx/Rx capable UE. If UE 110 is determined to be capable of simultaneous Tx/Rx operation, MME 420 can elect not to perform suspend control even if a related 1x procedure (e.g., as shown by flow diagram 200) occurs.

By way of specific, non-limiting example, system 400 can be employed in the context of a wireless network environment that utilizes Enhanced 1x CSFB (e1xCSFB) as a voice solution in LTE. For example, various aspects relating to system 400 as described herein can be utilized for a network deployment that utilizes Simultaneous Voice-LTE (SVLTE) for simultaneous voice and data communication. For example, system 400 can be utilized to reduce standby time impact caused by monitoring of multiple domains (e.g., 1x and LTE) by an associated UE simultaneously by, for example, providing a single domain paging solution for SVLTE.

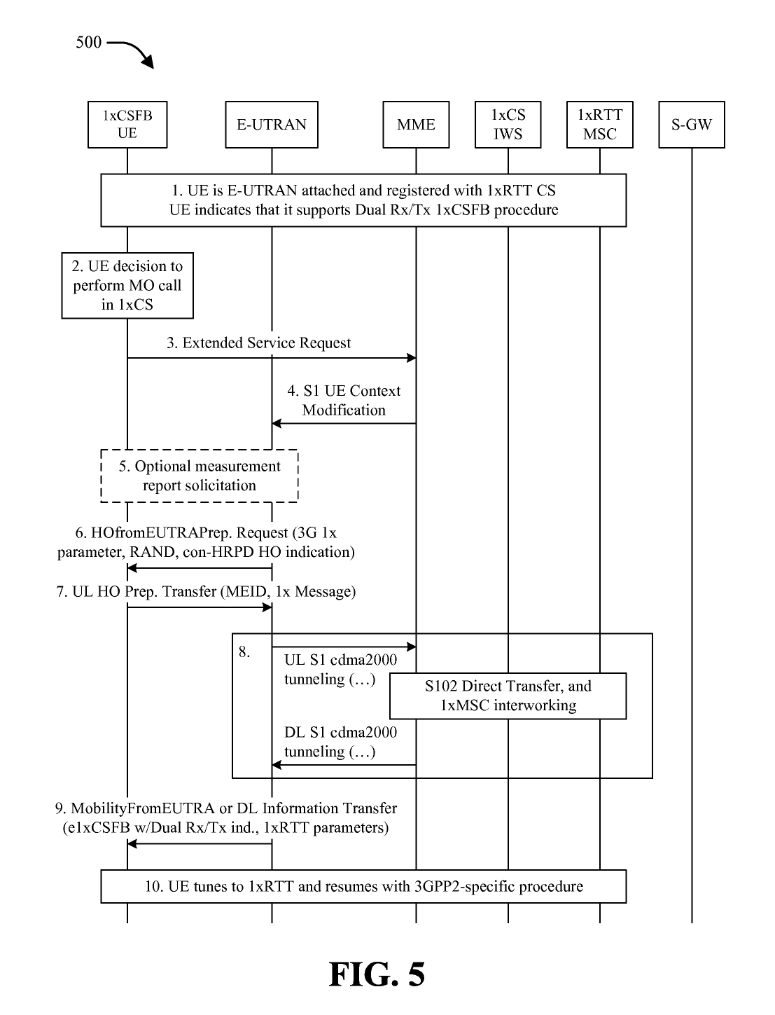

In accordance with one aspect, an example procedure that can be utilized for single-domain paging for SVLTE is shown by flow diagram 500 in FIG. 5. As FIG. 5 illustrates, a UE can initially be camped on LTE, and a 1x radio can be enabled when a 1xCSFB procedure for Mobile Termination (MT) or MO is executed. However, unlike traditional 1xCSFB, it can be appreciated that a data session associated with the UE is not suspended in all cases. Instead, as flow diagram 500 illustrates, an MME can decide whether or not to perform suspend control based on the capabilities of the UE. In the event that the data session is not suspended, the UE can abstain from performing Tracking Area Update (TAU) and/or Service Request procedures when an associated 1x call ends. In accordance with another aspect, some or all of the procedures illustrated by flow diagram 500 can be extended to the case of single-band 1x and LTE transmission and/or any other suitable use cases.

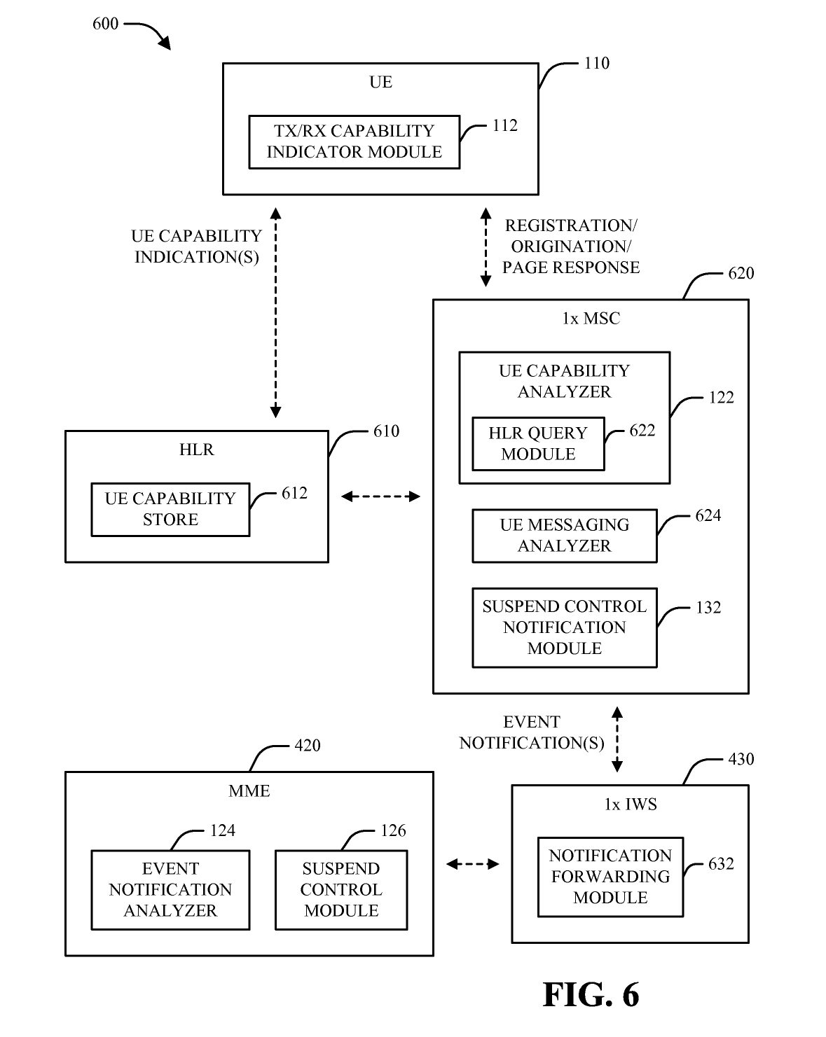

Turning now to FIG. 6, a block diagram of a system 600 for providing notification signaling for data session suspension based on determined user capabilities in accordance with various aspects is illustrated. As shown in FIG. 6, system 600 can include a UE 110, which can interact with a HLR 610 and communicate with one or more networks, such as a 1x network that includes a MSC 620 and an IWS 430, an LTE network including a MME 420, and/or other suitable network(s). In accordance with one aspect, UE 110 can indicate its Tx/Rx capability to HLR 610 (e.g., via Tx/Rx capability indicator module 112) to enable HLR to store the capability of UE 110 (e.g., using a UE capability store 612 and/or other means). In one example, HLR 610 can maintain profile information for an associated UE 110 that includes the Tx/Rx capability of UE 110. Subsequently, MSC 620 can query the capability of UE 110 and/or otherwise obtain information relating to Tx/Rx capability of an associated UE 110 from HLR 610 (e.g., via a HLR query module 622 associated with a UE capability analyzer 122, and/or other suitable means) when an event happens in the 1x network (e.g., such as that shown by step 3 in flow diagram 300). Depending on the determined capabilities of UE 110, MSC 620 can send an Event Notification and/or another suitable notification of a connection event to IWS 430 and/or another suitable network entity, which can in turn forward the notification of the connection event to MME 420 (e.g., via notification forwarding module 632) and/or another entity associated with a network with which IWS 430 communicates.

In accordance with one aspect, UE 110 can additionally provide signaling relating to a connection event to MSC 620. Based on the Tx/Rx capability of UE 110 and the signaling relating to the connection event, MSC 620 can (e.g., via a UE messaging analyzer 624 and/or suspend control notification module 132) determine whether to provide notification signaling to IWS 430. In a first example, MSC 620 can obtain information from HLR 610 indicating that UE 110 monitors one RAT at a time (e.g., case 1). Accordingly, MSC 620 can provide a notification of a connection event relating to UE 110 to IWS 430 upon receiving at least one of registration, origination, or page response signaling within signaling relating to the connection event received from UE 110. In a second example, MSC 620 can obtain information from HLR 610 indicating that UE 110 monitors two or more RATs simultaneously and transmits over one RAT at a time (e.g., case 2). In response, MSC 620 can provide a notification of a connection event relating to UE 110 to IWS 430 upon receiving at least one of origination or page response signaling within signaling relating to the connection event received from UE 110. In a third example, MSC 620 can obtain information from HLR 610 indicating that UE 110 transmits and receives on two or more RATs simultaneously (e.g., case 3) or that UE 110 transmits and receives on two or more RATs simultaneously and monitors one RAT at a time. In response, MSC 620 can elect not to provide a notification of a related connection event to IWS 430.

In accordance with another aspect, upon receiving event notification signaling from IWS 430, MME 420 can be configured to perform suspend control (e.g., via an event notification analyzer and/or suspend control module 126) in substantially all cases. Thus, it can be appreciated that, for the operation described with respect to system 600, suspend control can be performed by MME 420 whenever an event notification is received from IWS 430.

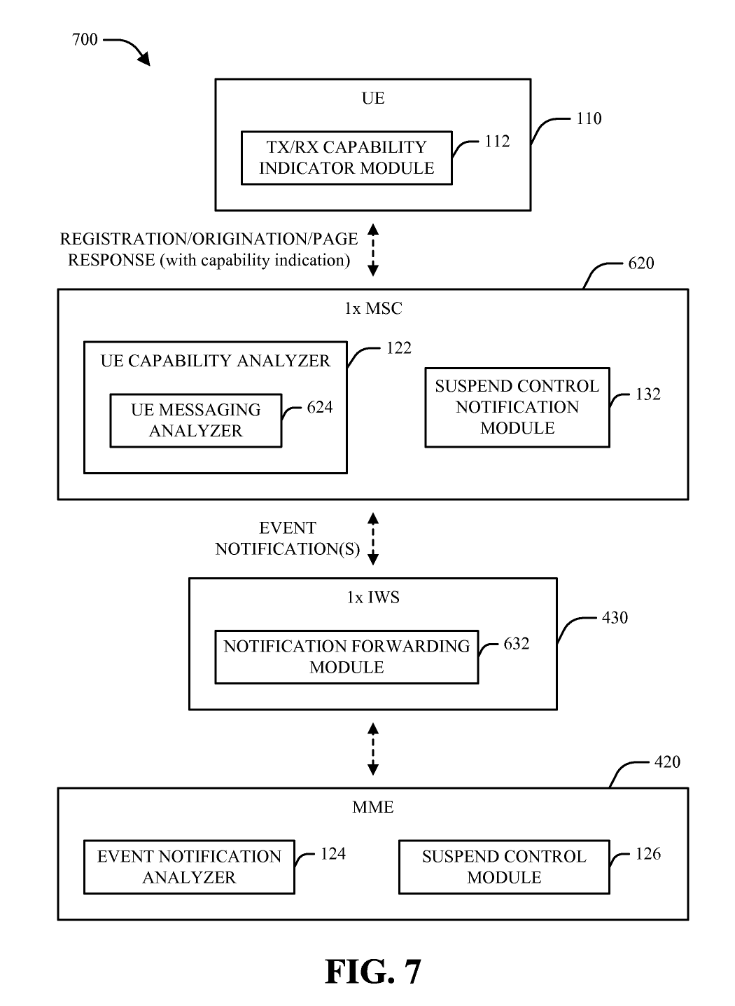

Referring to FIG. 7, another system 700 for providing notification signaling for data session suspension based on determined user capabilities in accordance with various aspects is illustrated. As FIG. 7 illustrates, system 700 can include a UE 110, a MSC 620, an IWS 430, and a MME 420, which can operate in accordance with various aspects as generally described above. In one example and in contrast to system 600 in FIG. 6, UE 110 operating with respect to one RAT (e.g., LTE) can be operable to directly indicate its Tx/Rx capability to a disparate RAT (e.g., cdma2000 1x). Thus, for example, instead of querying from a HLR, a MSC 620 can obtain information relating to Tx/Rx capability of an associated UE 110 directly from UE 110. In one example, at least one of registration, origination, page response, and/or other signaling relating to a connection event provided by UE 110 to MSC 620 can be configured to carry Tx/Rx capability information. Accordingly, information relating to capability of a UE 110 can be received by MSC 620 within signaling received from the UE 110 relating to a connection event.

In one example, UE 110 can determine its Tx/Rx capability level by selecting from a group of capability levels that includes Tx/Rx capability for a single network at a time (e.g., case 1), Rx capability for multiple networks simultaneously and Tx capability for a single network at a time (e.g., case 2), Tx/Rx capability for multiple networks simultaneously (e.g., case 3), and, and Tx/Rx capability for multiple networks simultaneously and monitoring capability for a single network at a time. Based on such capability levels, MSC 620 can determine (e.g., via a UE capability analyzer 122 and/or an associated UE messaging analyzer 624) whether or not to provide event notification signaling to an IWS 430 for forwarding to MME 420 in a similar manner to that described above with respect to system 600.

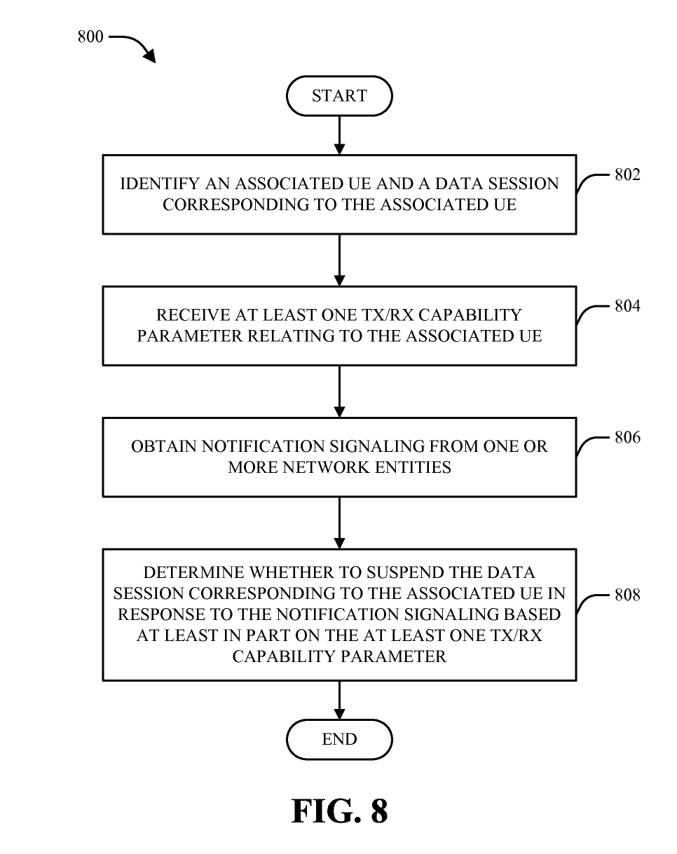

Referring now to FIGS. 8-13, methodologies that can be performed in accordance with various aspects set forth herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

With reference to FIG. 8, illustrated is a method 800 that facilitates data session suspend control in a wireless communication environment based on UE capability. It is to be appreciated that method 800 can be performed by, for example, a wireless communication network (e.g., network 120, etc.) and/or any other appropriate network entity. Method 800 begins at block 802, wherein an associated UE (e.g., UE 110) and a data session corresponding to the associated UE are identified. At block 804, at least one Tx/Rx capability parameter relating to the associated UE identified at block 802 is received. Next, at block 806, notification signaling is obtained from one or more network entities (e.g., IWS 430, etc.). Finally, at block 808, it is determined (e.g., via a UE capability analyzer 122, event notification analyzer 124, and/or suspend control module 126) whether to suspend the data session corresponding to the associated UE as identified at block 802 in response to the notification signaling obtained at block 806 based at least in part on the at least one Tx/Rx capability parameter received at block 804.

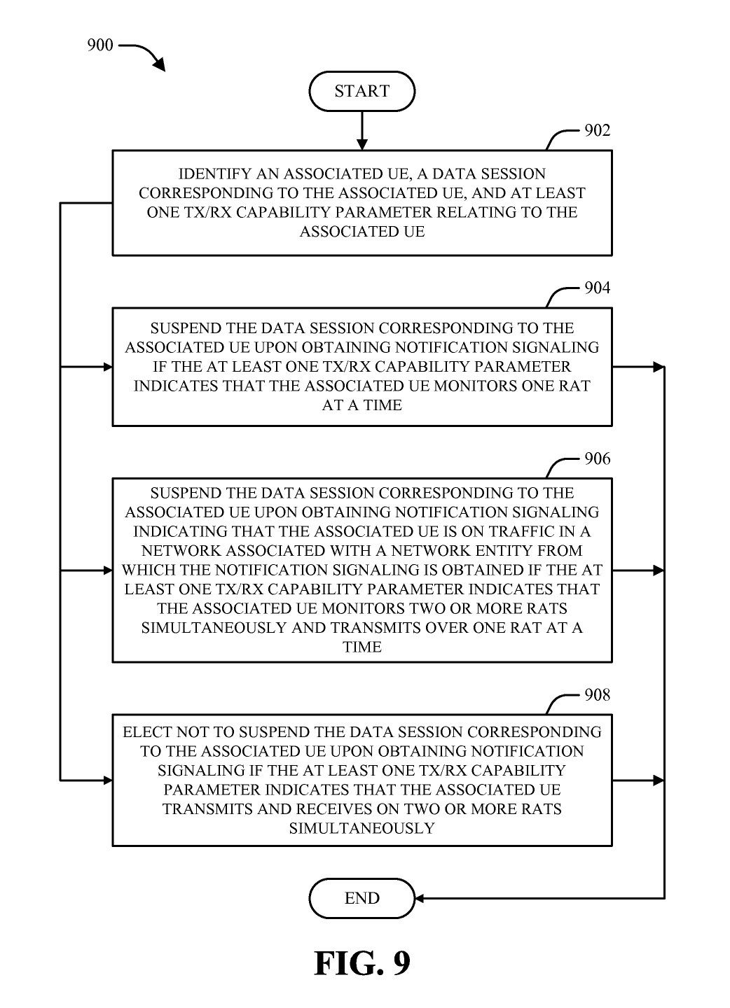

Turning next to FIG. 9, another method 900 that facilitates data session suspend control in a wireless communication environment based on UE capability is illustrated. Method 900 can be performed by, for example, a wireless network management entity and/or any other appropriate network entity. Method 900 begins at block 902, wherein an associated UE, a data session corresponding to the associated UE, and at least one Tx/Rx capability parameter relating to the associated UE are identified.

Upon completing the acts described at block 902, method 900 can proceed to one or more of blocks 904, 906, and/or 908 prior to concluding. At block 904, the data session corresponding to the associated UE identified at block 902 is suspended upon obtaining notification signaling if the at least one Tx/Rx capability parameter identified at block 902 indicates that the associated UE monitors one RAT at a time (e.g., corresponding to case 1). At block 906, the data session corresponding to the associated UE identified at block 902 is suspended upon obtaining notification signaling indicating that the associated UE is on traffic in a network associated with a network entity from which the notification signaling is obtained if the at least one Tx/Rx capability parameter identified at block 902 indicates that the associated UE monitors two or more RATs simultaneously and transmits over one RAT at a time (e.g., corresponding to case 2). At block 908, an election is made not to suspend the data session corresponding to the associated UE upon obtaining notification signaling if the at least one Tx/Rx capability parameter identified at block 902 indicates that the associated UE transmits and receives on two or more RATs simultaneously (e.g., corresponding to case 3).

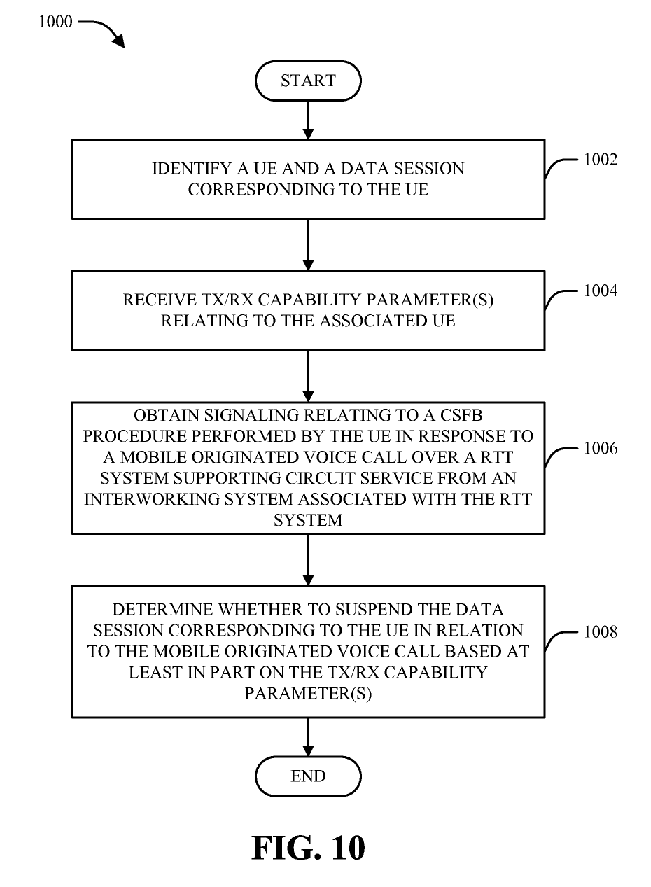

Referring to FIG. 10, a third method 1000 that facilitates data session suspend control in a wireless communication environment based on UE capability is illustrated. Method 1000 can be performed by, for example, a wireless network management entity (e.g., MME 420) that interacts with a RTT network that supports Circuit Service (e.g., a cdma2000 1x communication network, etc.) and/or any other appropriate network entity. Method 1000 begins at block 1002, wherein a UE and a data session corresponding to the UE are identified. Next, at block 1004, Tx/Rx capability parameter(s) relating to the associated UE identified at block 1002 are received. At block 1006, signaling is obtained that relates to a CSFB procedure performed by the UE in response to a mobile originated voice call over a RTT system supporting circuit service from a network interworking entity (e.g., IWS 430) associated with the RTT system. At block 1008, a determination is made regarding whether to suspend the data session corresponding to the UE in relation to the mobile originated voice call for which signaling is obtained at block 1006 based at least in part on the Tx/Rx capability parameter(s) received at block 1004.

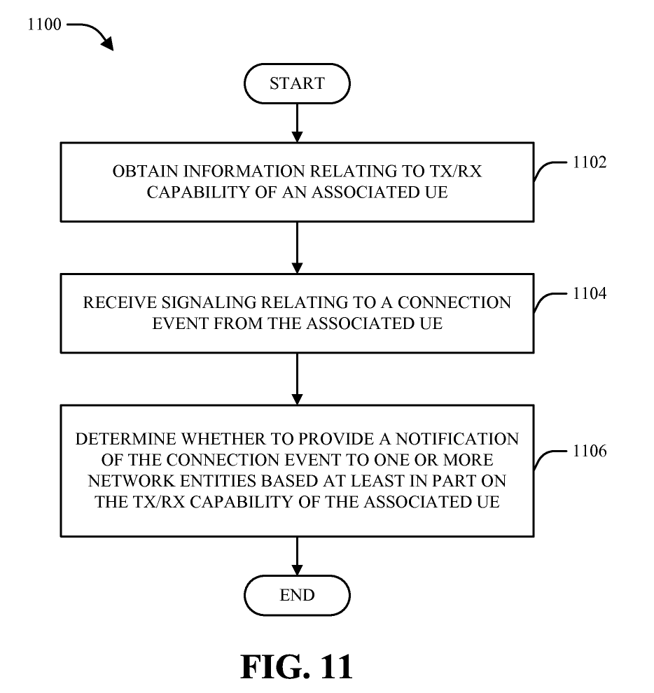

FIG. 11 illustrates a fourth method 1100 that facilitates data session suspend control in a wireless communication environment based on UE capability. Method 1100 can be performed by, for example, a wireless communication network (e.g., network 130) and/or any other appropriate network entity. Method 1100 can begin at block 1102, wherein information is obtained relating to Tx/Rx capability of an associated UE (e.g., UE 110). At block 1104, signaling is received from the associated UE identified at block 1102 relating to a connection event. At block 1106, a determination is made (e.g., via a suspend control notification module 132) regarding whether to provide a notification of the connection event to one or more network entities (e.g., IWS 430) based at least in part on the Tx/Rx capability of the associated UE identified at block 1102 (e.g., and as analyzed by a UE capability analyzer 122 and/or a UE messaging analyzer 624).

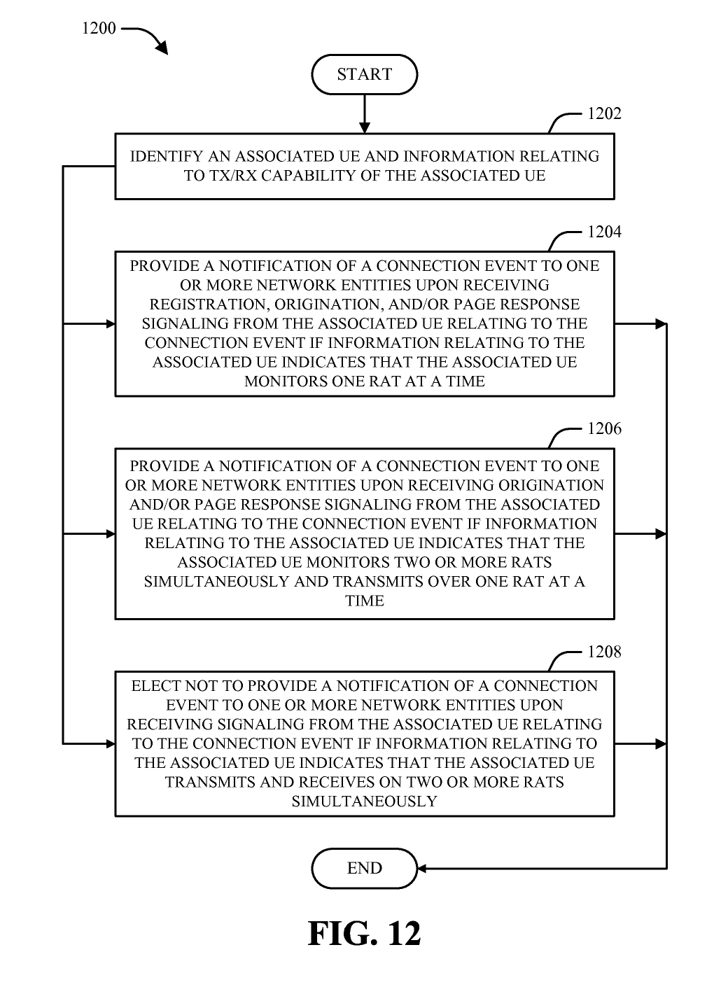

Referring now to FIG. 12, a fifth method 1200 that facilitates data session suspend control in a wireless communication environment based on UE capability is illustrated. Method 1200 can be performed by, for example, a wireless voice call management entity (e.g., MSC 620) and/or any other suitable network entity. Method 1200 can begin at block 1202, wherein an associated UE and information relating to Tx/Rx capability of the associated UE are identified.

Upon completing the acts described at block 1202, method 1200 can proceed to one or more of blocks 1204, 1206, and/or 1208 before concluding. At block 1204, a notification of a connection event can be provided to one or more network entities upon receiving registration, origination, and/or page response signaling relating to the connection event identified at block 1202 from the associated UE if information relating to the associated UE as further identified at block 1202 indicates that the associated UE monitors one RAT at a time (e.g., corresponding to case 1). At block 1206, a notification of a connection event can be provided to one or more network entities upon receiving origination and/or page response signaling relating to the connection event identified at block 1202 from the associated UE if information relating to the associated UE as further identified at block 1202 indicates that the associated UE monitors two or more RATs simultaneously and transmits over one RAT at a time (e.g., corresponding to case 2). At block 908, an election is made not to provide a notification of a connection event to one or more network entities upon receiving signaling relating to the connection event from the associated UE identified at block 1202 if information relating to the associated UE as further identified at block 1202 indicates that the associated UE transmits and receives on two or more RATs simultaneously (e.g., corresponding to case 3).

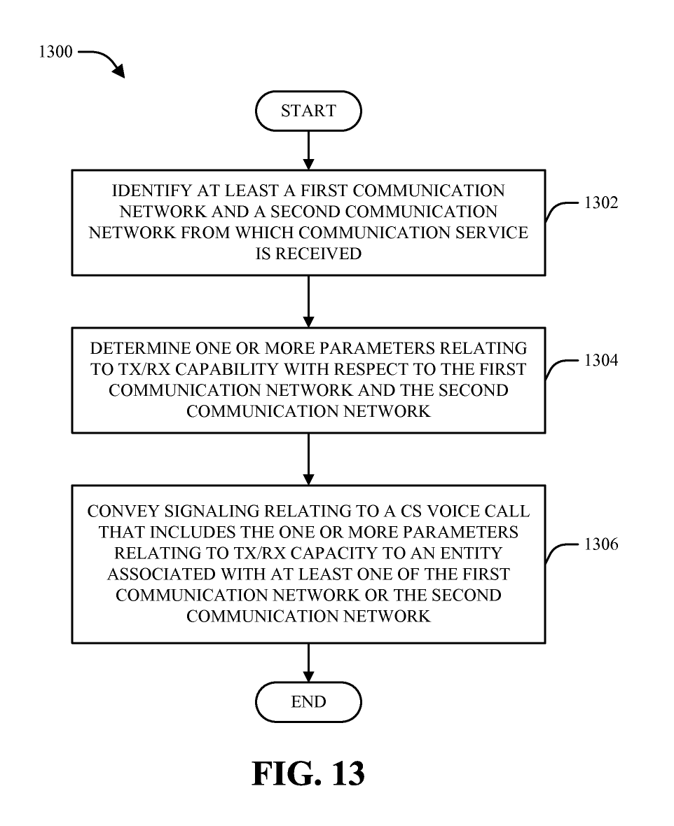

Turning to FIG. 13, a method 1300 that facilitates capability reporting with respect to communication sessions conducted within a wireless communication system is illustrated. It is to be appreciated that method 1300 can be performed by, for example, a mobile device (e.g., UE 110) and/or any other appropriate network entity. Method 1300 begins at block 1302, wherein at least a first communication network (e.g., network 120) and a second communication network (e.g., network 130) from which communication service is received are identified. At block 1304, one or more parameters relating to Tx/Rx capability with respect to the first communication network and the second communication network identified at block 1302 are determined. Method 1300 can then conclude at block 1306, wherein signaling relating to a CS voice call that includes the one or more parameters relating to Tx/Rx capacity determined at block 1304 is conveyed (e.g., by a Tx/Rx capability indicator module 112) to an entity associated with at least one of the first communication network or the second communication network.

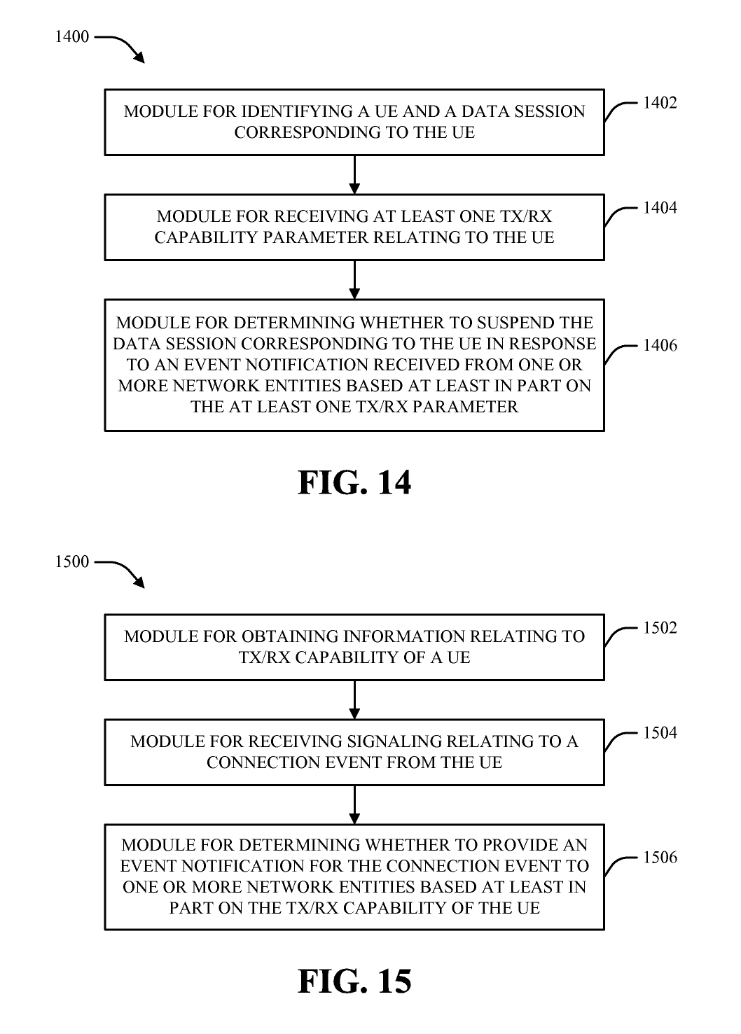

Referring next to FIGS. 14-16, respective apparatuses 1400-1600 that can facilitate various aspects described herein are illustrated. It is to be appreciated that apparatuses 1400-1600 are represented as including functional blocks, which can be functional blocks that represent functions implemented by a processor, software, or combination thereof (e.g., firmware).

With reference first to FIG. 14, an apparatus 1400 that facilitates data session management in a wireless communication environment is illustrated. Apparatus 1400 can be implemented by a communication network management entity (e.g., MME 420) and/or any other suitable network entity and can include a module 1402 for identifying a UE and a data session corresponding to the UE, a module 1404 for receiving at least one Tx/Rx capability parameter relating to the UE, and a module 1406 for determining whether to suspend the data session corresponding to the UE in response to an event notification received from one or more network entities based at least in part on the at least one Tx/Rx parameter.

Turning next to FIG. 15, a second apparatus 1500 that facilitates data session management in a wireless communication environment is illustrated. Apparatus 1500 can be implemented by a wireless voice call management entity (e.g., MSC 620) and/or any other suitable network entity and can include a module 1502 for obtaining information relating to Tx/Rx capability of a UE, a module 1504 for receiving signaling relating to a connection event from the UE, and a module 1506 for determining whether to provide an event notification for the connection event to one or more network entities based at least in part on the Tx/Rx capability of the UE.

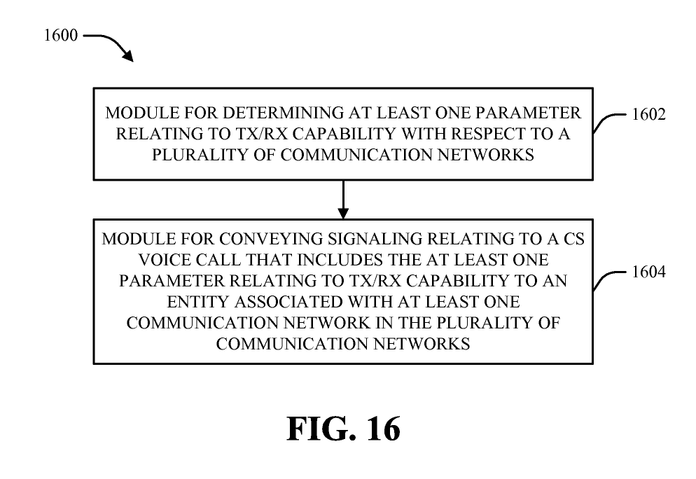

FIG. 16 illustrates a third apparatus 1600 that facilitates data session management in a wireless communication environment. Apparatus 1600 can be implemented by a mobile device (e.g., UE 110) and/or any other suitable network entity and can include a module 1602 for determining at least one parameter relating to Tx/Rx capability with respect to a plurality of communication networks and a module 1604 for conveying signaling relating to a CS voice call that includes the at least one parameter relating to Tx/Rx capability to an entity associated with at least one communication network in the plurality of communication networks.

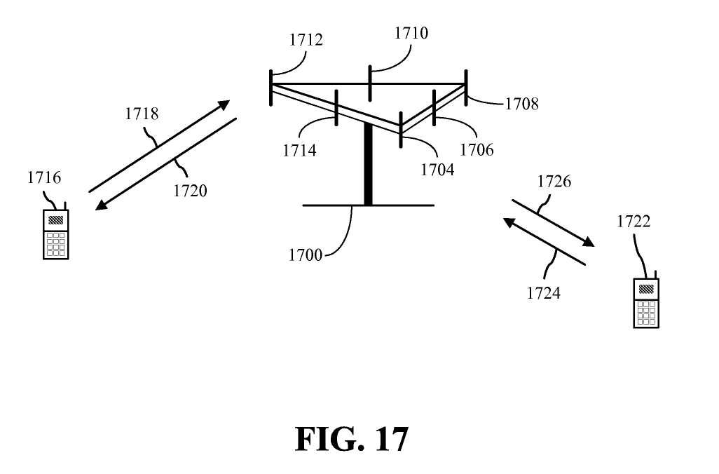

Referring now to FIG. 17, an illustration of a wireless multiple-access communication system is provided in accordance with various aspects. In one example, an access point 1700 (AP) includes multiple antenna groups. As illustrated in FIG. 17, one antenna group can include antennas 1704 and 1706, another can include antennas 1708 and 1710, and another can include antennas 1712 and 1714. While only two antennas are shown in FIG. 17 for each antenna group, it should be appreciated that more or fewer antennas may be utilized for each antenna group. In another example, an access terminal 1716 can be in communication with antennas 1712 and 1714, where antennas 1712 and 1714 transmit information to access terminal 1716 over forward link 1720 and receive information from access terminal 1716 over reverse link 1718. Additionally and/or alternatively, access terminal 1722 can be in communication with antennas 1706 and 1708, where antennas 1706 and 1708 transmit information to access terminal 1722 over forward link 1726 and receive information from access terminal 1722 over reverse link 1724. In a frequency division duplex system, communication links 1718, 1720, 1724 and 1726 can use different frequency for communication. For example, forward link 1720 may use a different frequency then that used by reverse link 1718.

Each group of antennas and/or the area in which they are designed to communicate can be referred to as a sector of the access point. In accordance with one aspect, antenna groups can be designed to communicate to access terminals in a sector of areas covered by access point 1700. In communication over forward links 1720 and 1726, the transmitting antennas of access point 1700 can utilize beamforming in order to improve the signal-to-noise ratio of forward links for the different access terminals 1716 and 1722. Also, an access point using beamforming to transmit to access terminals scattered randomly through its coverage causes less interference to access terminals in neighboring cells than an access point transmitting through a single antenna to all its access terminals.

An access point, e.g., access point 1700, can be a fixed station used for communicating with terminals and can also be referred to as a base station, an eNB, an access network, and/or other suitable terminology. In addition, an access terminal, e.g., an access terminal 1716 or 1722, can also be referred to as a mobile terminal, user equipment, a wireless communication device, a terminal, a wireless terminal, and/or other appropriate terminology.

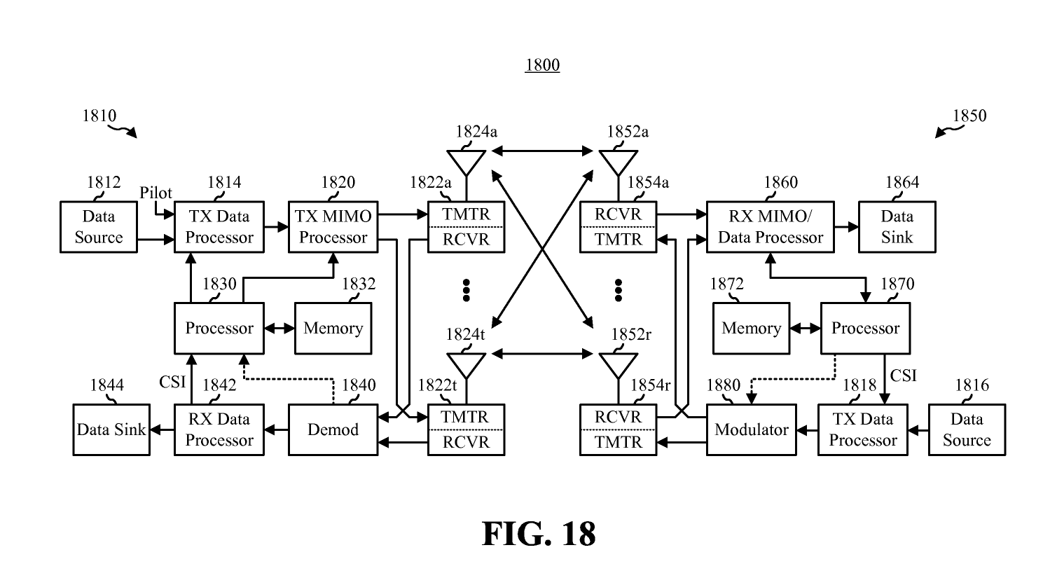

Referring now to FIG. 18, a block diagram illustrating an example wireless communication system 1800 in which various aspects described herein can function is provided. In one example, system 1800 is a multiple-input multiple-output (MIMO) system that includes a transmitter system 1810 and a receiver system 1850. It should be appreciated, however, that transmitter system 1810 and/or receiver system 1850 could also be applied to a multi-input single-output system wherein, for example, multiple transmit antennas (e.g., on a base station), can transmit one or more symbol streams to a single antenna device (e.g., a mobile station). Additionally, it should be appreciated that aspects of transmitter system 1810 and/or receiver system 1850 described herein could be utilized in connection with a single output to single input antenna system.

In accordance with one aspect, traffic data for a number of data streams are provided at transmitter system 1810 from a data source 1812 to a transmit (TX) data processor 1814. In one example, each data stream can then be transmitted via a respective transmit antenna 1824. Additionally, TX data processor 1814 can format, encode, and interleave traffic data for each data stream based on a particular coding scheme selected for each respective data stream in order to provide coded data. In one example, the coded data for each data stream can then be multiplexed with pilot data using OFDM techniques. The pilot data can be, for example, a known data pattern that is processed in a known manner. Further, the pilot data can be used at receiver system 1850 to estimate channel response. Back at transmitter system 1810, the multiplexed pilot and coded data for each data stream can be modulated (e.g., symbol mapped) based on a particular modulation scheme (e.g., BPSK, QSPK, M-PSK, or M-QAM) selected for each respective data stream in order to provide modulation symbols. In one example, data rate, coding, and modulation for each data stream can be determined by instructions performed on and/or provided by processor 1830.

Next, modulation symbols for all data streams can be provided to a TX MIMO processor 1820, which can further process the modulation symbols (e.g., for OFDM). TX MIMO processor 1820 can then provides N_{T} modulation symbol streams to N_{T} transceivers 1822a through 1822t. In one example, each transceiver 1822 can receive and process a respective symbol stream to provide one or more analog signals. Each transceiver 1822 can then further condition (e.g., amplify, filter, and upconvert) the analog signals to provide a modulated signal suitable for transmission over a MIMO channel. Accordingly, N_{T} modulated signals from transceivers 1822a through 1822t can then be transmitted from N_{T} antennas 1824a through 1824t, respectively.

In accordance with another aspect, the transmitted modulated signals can be received at receiver system 1850 by N_{R} antennas 1852a through 1852r. The received signal from each antenna 1852 can then be provided to respective transceivers 1854. In one example, each transceiver 1854 can condition (e.g., filter, amplify, and downconvert) a respective received signal, digitize the conditioned signal to provide samples, and then processes the samples to provide a corresponding “received” symbol stream. An RX MIMO/data processor 1860 can then receive and process the N_{R} received symbol streams from N_{R} transceivers 1854 based on a particular receiver processing technique to provide N_{T} “detected” symbol streams. In one example, each detected symbol stream can include symbols that are estimates of the modulation symbols transmitted for the corresponding data stream. RX processor 1860 can then process each symbol stream at least in part by demodulating, deinterleaving, and decoding each detected symbol stream to recover traffic data for a corresponding data stream. Thus, the processing by RX processor 1860 can be complementary to that performed by TX MIMO processor 1820 and TX data processor 1814 at transmitter system 1810. RX processor 1860 can additionally provide processed symbol streams to a data sink 1864.

In accordance with one aspect, the channel response estimate generated by RX processor 1860 can be used to perform space/time processing at the receiver, adjust power levels, change modulation rates or schemes, and/or other appropriate actions. Additionally, RX processor 1860 can further estimate channel characteristics such as, for example, signal-to-noise-and-interference ratios (SNRs) of the detected symbol streams. RX processor 1860 can then provide estimated channel characteristics to a processor 1870. In one example, RX processor 1860 and/or processor 1870 can further derive an estimate of the “operating” SNR for the system. Processor 1870 can then provide channel state information (CSI), which can comprise information regarding the communication link and/or the received data stream. This information can include, for example, the operating SNR. The CSI can then be processed by a TX data processor 1818, modulated by a modulator 1880, conditioned by transceivers 1854a through 1854r, and transmitted back to transmitter system 1810. In addition, a data source 1816 at receiver system 1850 can provide additional data to be processed by TX data processor 1818.

Back at transmitter system 1810, the modulated signals from receiver system 1850 can then be received by antennas 1824, conditioned by transceivers 1822, demodulated by a demodulator 1840, and processed by a RX data processor 1842 to recover the CSI reported by receiver system 1850. In one example, the reported CSI can then be provided to processor 1830 and used to determine data rates as well as coding and modulation schemes to be used for one or more data streams. The determined coding and modulation schemes can then be provided to transceivers 1822 for quantization and/or use in later transmissions to receiver system 1850. Additionally and/or alternatively, the reported CSI can be used by processor 1830 to generate various controls for TX data processor 1814 and TX MIMO processor 1818. In another example, CSI and/or other information processed by RX data processor 1842 can be provided to a data sink 1844.

In one example, processor 1830 at transmitter system 1810 and processor 1870 at receiver system 1850 direct operation at their respective systems. Additionally, memory 1832 at transmitter system 1810 and memory 1872 at receiver system 1850 can provide storage for program codes and data used by processors 1830 and 1870, respectively. Further, at receiver system 1850, various processing techniques can be used to process the N_{R} received signals to detect the N_{T} transmitted symbol streams. These receiver processing techniques can include spatial and space-time receiver processing techniques, which can also be referred to as equalization techniques, and/or “successive nulling/equalization and interference cancellation” receiver processing techniques, which can also be referred to as “successive interference cancellation” or “successive cancellation” receiver processing techniques.

It is to be understood that the aspects described herein can be implemented by hardware, software, firmware, middleware, microcode, or any combination thereof. When the systems and/or methods are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

What has been described above includes examples of one or more aspects. It is, of course, not possible to describe every conceivable combination of components or methodologies for purposes of describing the aforementioned aspects, but one of ordinary skill in the art can recognize that many further combinations and permutations of various aspects are possible. Accordingly, the described aspects are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is meant to be a “non-exclusive or.”

What is claimed is:

1. A method, comprising:
identifying an associated user equipment unit (UE) and a data session corresponding to the associated UE;
receiving at least one transmitter (Tx)/receiver (Rx) capability parameter relating to the associated UE;
obtaining notification signaling from one or more network entities; and
determining whether to suspend the data session corresponding to the associated UE in response to the notification signaling based at least in part on the at least one Tx/Rx capability parameter.

2. The method of claim 1, wherein the obtaining comprises obtaining notification signaling relating to a circuit-switched fallback (CSFB) procedure performed by the associated UE.

3. The method of claim 2, wherein the one or more network entities comprise an interworking system associated with a Radio Transmission Technology (RTT) system supporting circuit service and the obtaining further comprises obtaining notification signaling relating to access of the associated UE to the RTT system via the CSFB procedure.

4. The method of claim 3, wherein the CSFB procedure is performed by the associated UE in response to at least one of a mobile originated 1xRTT voice call or a mobile terminated 1xRTT voice call.

5. The method of claim 1, wherein:
the at least one Tx/Rx capability parameter indicates that the associated UE monitors one radio access technology (RAT) at a time; and
the determining comprises suspending the data session corresponding to the associated UE upon obtaining the notification signaling.

6. The method of claim 1, wherein:
the at least one Tx/Rx capability parameter indicates that the associated UE monitors two or more radio access technologies (RATs) simultaneously and transmits over one RAT at a time; and
the determining comprises suspending the data session corresponding to the associated UE if obtained notification signaling indicates that the associated UE is on traffic in a network associated with the one or more network entities.

7. The method of claim 1, wherein:
the at least one Tx/Rx capability parameter indicates that the associated UE transmits and receives on two or more radio access technologies (RATs) simultaneously; and
the determining comprises electing not to suspend the data session corresponding to the associated UE upon obtaining the notification signaling.

8. The method of claim 1, wherein:
the at least one Tx/Rx capability parameter indicates that the associated UE transmits and receives on two or more radio access technologies (RATs) simultaneously and monitors one RAT at a time; and
the determining comprises electing not to suspend the data session corresponding to the associated UE upon obtaining the notification signaling.

9. The method of claim 1, further comprising signaling a data session suspend request to an associated serving gateway upon determining that the data session corresponding to the associated UE is to be suspended.

10. The method of claim 1, wherein the receiving comprises receiving the at least one Tx/Rx capability parameter from an Evolved UMTS (Universal Mobile Telecommunications System) Terrestrial Radio Access Network (E-UTRAN) providing communication service to the associated UE.

11. The method of claim 1, wherein the obtaining comprises obtaining notification signaling indicative of movement of the associated UE to coverage of a network corresponding to the one or more network entities.

12. A wireless communications apparatus, comprising:
a memory that stores data relating to an associated user equipment unit (UE), a data session corresponding to the associated UE, and at least one transmitter (Tx)/receiver (Rx) capability parameter relating to the associated UE; and
a processor configured to obtain notification signaling from one or more network entities and to determine whether to suspend the data session corresponding to the associated UE in response to the notification signaling based at least in part on the at least one Tx/Rx capability parameter.

13. The wireless communications apparatus of claim 12, wherein the one or more network entities comprise an interworking system associated with a Radio Transmission Technology (RTT) system that supports circuit service and the notification signaling relates to a circuit-switched fallback (CSFB) procedure performed by the associated UE in response to at least one of a mobile originated RTT voice call or a mobile terminated RTT voice call.

14. The wireless communications apparatus of claim 12, wherein:
the at least one Tx/Rx capability parameter indicates that the associated UE monitors one radio access technology (RAT) at a time; and
the processor is further configured to suspend the data session corresponding to the associated UE upon obtaining the notification signaling.

15. The wireless communications apparatus of claim 12, wherein:
the at least one Tx/Rx capability parameter indicates that the associated UE monitors two or more radio access technologies (RATs) simultaneously and transmits over one RAT at a time; and
the processor is further configured to suspend the data session corresponding to the associated UE if obtained notification signaling indicates that the associated UE is on traffic in a network associated with the one or more network entities.

16. The wireless communications apparatus of claim 12, wherein:
the at least one Tx/Rx capability parameter indicates that the associated UE transmits and receives on two or more radio access technologies (RATs) simultaneously; and
the processor is further configured to refrain from suspending the data session corresponding to the associated UE upon obtaining the notification signaling.

17. The wireless communications apparatus of claim 12, wherein:
the at least one Tx/Rx capability parameter indicates that the associated UE transmits and receives on two or more radio access technologies (RATs) simultaneously and monitors one RAT at a time; and
the processor is further configured to refrain from suspending the data session corresponding to the associated UE upon obtaining the notification signaling.

18. The wireless communications apparatus of claim 12, wherein the processor is further configured to signal a data session suspend request to an associated serving gateway upon determining that the data session corresponding to the associated UE is to be suspended.

19. The wireless communications apparatus of claim 12, wherein the processor is further configured to receive the at least one Tx/Rx capability parameter from an Evolved UMTS (Universal Mobile Telecommunications System) Terrestrial Radio Access Network (E-UTRAN) providing communication service to the associated UE.

20. An apparatus, comprising:
means for identifying a user equipment unit (UE) and a data session corresponding to the UE;
means for receiving at least one transmitter (Tx)/receiver (Rx) capability parameter relating to the UE; and
means for determining whether to suspend the data session corresponding to the UE in response to an event notification received from one or more network entities based at least in part on the at least one Tx/Rx capability parameter.

21. The apparatus of claim 20, wherein:
the one or more network entities comprise a network interworking entity associated with a Radio Transmission Technology (RTT) system that supports circuit service; and
the notification signaling relates to a circuit-switched fallback (CSFB) procedure performed by the UE in response to at least one of a mobile originated RTT voice call or a mobile terminated RTT voice call.

22. The apparatus of claim 20, wherein:
the at least one Tx/Rx capability parameter indicates that the UE monitors one radio access technology (RAT) at a time; and
the means for determining comprises means for suspending the data session corresponding to the UE upon receiving the event notification.

23. The apparatus of claim 20, wherein:
the at least one Tx/Rx capability parameter indicates that the UE monitors two or more radio access technologies (RATs) simultaneously and transmits over one RAT at a time; and
the means for determining comprises means for suspending the data session corresponding to the UE if the event notification indicates that the UE is on traffic in a network associated with the one or more network entities.

24. The apparatus of claim 20, wherein:
the at least one Tx/Rx capability parameter indicates that the UE transmits and receives on two or more radio access technologies (RATs) simultaneously; and
the means for determining comprises means for refraining from suspending the data session corresponding to the UE upon obtaining the event notification.

25. The apparatus of claim 20, wherein:
the at least one Tx/Rx capability parameter indicates that the UE transmits and receives on two or more radio access technologies (RATs) simultaneously and monitors one RAT at a time; and
the means for determining comprises means for refraining from suspending the data session corresponding to the UE upon obtaining the event notification.

26. The apparatus of claim 20, further comprising means for signaling a data session suspend request to an associated serving gateway upon determining that the data session corresponding to the UE is to be suspended.

27. A computer program product, comprising:
a computer-readable medium, comprising:
code for causing a computer to identify a user equipment unit (UE) and a data session corresponding to the UE;
code for causing a computer to receive at least one transmitter (Tx)/receiver (Rx) capability parameter relating to the UE; and
code for causing a computer to determine whether to suspend the data session corresponding to the UE in response to an event notification received from one or more network entities based at least in part on the at least one Tx/Rx capability parameter.

28. The computer program product of claim 27, wherein:
the at least one Tx/Rx capability parameter indicates that the UE monitors one radio access technology (RAT) at a time; and
the code for causing a computer to determine comprises code for causing a computer to suspend the data session corresponding to the UE upon receiving the event notification.

29. The computer program product of claim 27, wherein:
the at least one Tx/Rx capability parameter indicates that the UE monitors two or more radio access technologies (RATs) simultaneously and transmits over one RAT at a time; and
the code for causing a computer to determine comprises code for causing a computer to suspend the data session corresponding to the UE if the event notification indicates that the UE is on traffic in a network associated with the one or more network entities.

30. The computer program product of claim 27, wherein:
the at least one Tx/Rx capability parameter indicates that the UE transmits and receives on two or more radio access technologies (RATs) simultaneously; and
the code for causing a computer to determine comprises code for causing a computer to refrain from suspending the data session corresponding to the UE upon obtaining the event notification.

31. The computer program product of claim 27, wherein:
the at least one Tx/Rx capability parameter indicates that the UE transmits and receives on two or more radio access technologies (RATs) simultaneously and monitors one RAT at a time; and
the code for causing a computer to determine comprises code for causing a computer to refrain from suspending the data session corresponding to the UE upon obtaining the event notification.

32. A method, comprising:
obtaining information relating to transmitter (Tx)/receiver (Rx) capability of an associated user equipment unit (UE);
receiving signaling relating to a connection event from the associated UE; and
determining whether to provide a notification of the connection event to one or more network entities based at least in part on the Tx/Rx capability of the associated UE.

33. The method of claim 32, wherein the obtaining comprises obtaining the information relating to Tx/Rx capability of the associated UE from a home location register (HLR) that maintains profile information for the associated UE.

34. The method of claim 32, wherein the obtaining comprises obtaining the information relating to Tx/Rx capability of the associated UE within the signaling received from the associated UE relating to the connection event.

35. The method of claim 32, wherein:
the obtaining comprises obtaining information indicating that the associated UE monitors one radio access technology (RAT) at a time; and
the determining comprises providing a notification of the connection event to the one or more network entities upon receiving at least one of registration, origination, or page response signaling within the signaling relating to the connection event.

36. The method of claim 32, wherein:
the obtaining comprises obtaining information that the associated UE monitors two or more radio access technologies (RATs) simultaneously and transmits over one RAT at a time; and
the determining comprises providing a notification of the connection event to the one or more network entities upon receiving at least one of origination or page response signaling within the signaling relating to the connection event.

37. The method of claim 32, wherein:
the obtaining comprises obtaining information that the associated UE transmits and receives on two or more radio access technologies (RATs) simultaneously; and
the determining comprises electing not to provide a notification of the connection event to the one or more network entities.

38. The method of claim 32, wherein:
the obtaining comprises obtaining information that the associated UE transmits and receives on two or more radio access technologies (RATs) simultaneously and monitors one RAT at a time; and
the determining comprises electing not to provide a notification of the connection event to the one or more network entities.

39. The method of claim 32, wherein the one or more network entities comprise a network interworking entity and the notification of the connection event is forwarded from the network interworking entity to a mobility management entity associated with a network with which the network interworking entity communicates.

40. A wireless communications apparatus, comprising:
a memory that stores data relating to information indicative of transmitter (Tx)/receiver (Rx) capability of an associated user equipment unit (UE); and
a processor configured to receive signaling relating to a connection event from the associated UE and to determine whether to provide a notification of the connection event to one or more network entities based at least in part on the Tx/Rx capability of the associated UE.

41. The wireless communications apparatus of claim 40, wherein the processor is further configured to obtain the information indicative of Tx/Rx capability of the associated UE from at least one of a home location register (HLR) that maintains profile information for the associated UE or the signaling received from the associated UE relating to the connection event.

42. The wireless communications apparatus of claim 40, wherein:
the information indicative of Tx/Rx capability of the associated UE indicates that the associated UE monitors one radio access technology (RAT) at a time; and
the processor is further configured to provide a notification of the connection event to the one or more network entities upon receiving at least one of registration, origination, or page response signaling within the signaling relating to the connection event.

43. The wireless communications apparatus of claim 40, wherein:
the information indicative of Tx/Rx capability of the associated UE indicates that the associated UE monitors two or more radio access technologies (RATs) simultaneously and transmits over one RAT at a time; and
the processor is further configured to provide a notification of the connection event to the one or more network entities upon receiving at least one of origination or page response signaling within the signaling relating to the connection event.

44. The wireless communications apparatus of claim 40, wherein:
the information indicative of Tx/Rx capability of the associated UE indicates that the associated UE transmits and receives on two or more radio access technologies (RATs) simultaneously; and
the processor is further configured to elect not to provide a notification of the connection event to the one or more network entities.

45. The wireless communications apparatus of claim 40, wherein:
the information indicative of Tx/Rx capability of the associated UE indicates that the associated UE transmits and receives on two or more radio access technologies (RATs) simultaneously and monitors one RAT at a time; and
the processor is further configured to elect not to provide a notification of the connection event to the one or more network entities.

46. An apparatus, comprising:
means for obtaining information relating to transmitter (Tx)/receiver (Rx) capability of a user equipment unit (UE);
means for receiving signaling relating to a connection event from the UE; and
means for determining whether to provide an event notification for the connection event to one or more network entities based at least in part on the Tx/Rx capability of the UE.

47. The apparatus of claim 46, wherein the means for obtaining comprises means for obtaining the information relating to Tx/Rx capability of the UE from at least one of a home location register (HLR) that maintains profile information for the UE or the signaling relating to the connection event received from the UE.

48. The apparatus of claim 46, wherein the means for determining comprises one or more of:
means for providing an event notification for the connection event to the one or more network entities if the information relating to Tx/Rx capability of the UE indicates that the UE monitors one radio access technology (RAT) at a time;
means for providing an event notification for the connection event to the one or more network entities if the information relating to Tx/Rx capability of the UE indicates that the UE monitors two or more RATs simultaneously and transmits over one RAT at a time and at least one of origination or page response signaling is received within the signaling relating to the connection event; or
means for refraining from providing an event notification for the connection event to the one or more network entities if the information relating to Tx/Rx capability of the UE indicates that the UE transmits and receives on two or more RATs simultaneously.

49. A computer program product, comprising:
a computer-readable medium, comprising:
code for causing a computer to obtain information relating to transmitter (Tx)/receiver (Rx) capability of a user equipment unit (UE);
code for causing a computer to receive signaling relating to a connection event from the UE; and
code for causing a computer to determine whether to provide an event notification for the connection event to an interworking system based at least in part on the Tx/Rx capability of the UE.

50. The computer program product of claim 49, wherein the code for causing a computer to obtain comprises code for causing a computer to obtain the information relating to Tx/Rx capability of the UE from at least one of a home location register (HLR) that maintains profile information for the UE or the signaling relating to the connection event received from the UE.

51. The computer program product of claim 49, wherein the code for causing a computer to determine comprises one or more of:
code for causing a computer to provide an event notification for the connection event to the interworking system if the information relating to Tx/Rx capability of the UE indicates that the UE monitors one radio access technology (RAT) at a time;
code for causing a computer to provide an event notification for the connection event to the interworking system if the information relating to Tx/Rx capability of the UE indicates that the UE monitors two or more RATs simultaneously and transmits over one RAT at a time and at least one of origination or page response signaling is received within the signaling relating to the connection event; or
code for causing a computer to refrain from providing an event notification for the connection event to the interworking system if the information relating to Tx/Rx capability of the UE indicates that the UE transmits and receives on two or more RATs simultaneously.

52. A method, comprising:
identifying at least a first communication network and a second communication network from which communication service is received;
determining one or more parameters relating to transmitter (Tx)/receiver (Rx) capability with respect to the first communication network and the second communication network; and
conveying signaling relating to a circuit switched (CS) voice call that includes the one or more parameters relating to Tx/Rx capability to an entity associated with at least one of the first communication network or the second communication network.

53. The method of claim 52, wherein the conveying comprises conveying the one or more parameters relating to Tx/Rx capacity to an Evolved UMTS (Universal Mobile Telecommunications System) Terrestrial Radio Access Network (E-UTRAN) associated with at least one of the first communication network or the second communication network.

54. The method of claim 52, wherein the conveying comprises conveying the one or more parameters relating to Tx/Rx capacity to a home location register (HLR) associated with at least one of the first communication network or the second communication network.

55. The method of claim 52, wherein the conveying comprises conveying the one or more parameters relating to Tx/Rx capacity to a mobile switching center (MSC) associated with at least one of the first communication network or the second communication network.

56. The method of claim 55, wherein the conveying further comprises conveying the one or more parameters relating to Tx/Rx capacity to the MSC within at least one of registration, origination, or page response signaling.

57. The method of claim 52, wherein the determining comprises identifying a Tx/Rx capability level selected from the group consisting of Tx/Rx capability for a single network at a time, Rx capability for multiple networks simultaneously and Tx capability for a single network at a time, Tx/Rx capability for multiple networks simultaneously, and Tx/Rx capability for multiple networks simultaneously and monitoring capability for a single network at a time.

58. A wireless communications apparatus, comprising:
a memory that stores data relating to at least a first communication network and a second communication network from which communication service is received; and
a processor configured to determine one or more parameters relating to transmitter (Tx)/receiver (Rx) capability with respect to the first communication network and the second communication network and to convey signaling relating to a circuit switched (CS) voice call that includes the one or more parameters relating to Tx/Rx capability to an entity associated with at least one of the first communication network or the second communication network.

59. The wireless communications apparatus of claim 58, wherein the processor is further configured to convey the one or more parameters relating to Tx/Rx capability to at least one of an Evolved UMTS (Universal Mobile Telecommunications System) Terrestrial Radio Access Network (E-UTRAN) associated with at least one of the first communication network or the second communication network, a home location register (HLR) associated with at least one of the first communication network or the second communication network, or a mobile switching center (MSC) associated with at least one of the first communication network or the second communication network.

60. The wireless communications apparatus of claim 58, wherein the processor is further configured to identify a Tx/Rx capability level selected from the group consisting of Tx/Rx capability for a single network at a time, Rx capability for multiple networks simultaneously and Tx capability for a single network at a time, Tx/Rx capability for multiple networks simultaneously, and Tx/Rx capability for multiple networks simultaneously and monitoring capability for a single network at a time.

61. An apparatus, comprising:
means for determining at least one parameter relating to transmitter (Tx)/receiver (Rx) capability with respect to a plurality of communication networks; and
means for conveying signaling relating to a circuit switched (CS) voice call that includes the at least one parameter relating to Tx/Rx capability to an entity associated with at least one communication network in the plurality of communication networks.

62. The apparatus of claim 61, wherein the means for conveying comprises means for conveying the at least one parameter relating to Tx/Rx capability to at least one of an Evolved UMTS (Universal Mobile Telecommunications System) Terrestrial Radio Access Network (E-UTRAN), a home location register (HLR), or a mobile switching center (MSC) associated with at least one communication network in the plurality of communication networks.

63. The apparatus of claim 61, wherein the means for determining comprises means for identifying a Tx/Rx capability level selected from the group consisting of Tx/Rx capability for a single network at a time, Rx capability for multiple networks simultaneously and Tx capability for a single network at a time, and Tx/Rx capability for multiple networks simultaneously.

64. A computer program product, comprising:
a computer-readable medium, comprising:
code for causing a computer to determine at least one parameter relating to transmitter (Tx)/receiver (Rx) capability with respect to a plurality of communication networks; and
code for causing a computer to convey signaling relating to a circuit switched (CS) voice call that includes the at least one parameter relating to Tx/Rx capability to an entity associated with at least one communication network in the plurality of communication networks.

65. The computer program product of claim 64, wherein the code for causing a computer to convey comprises code for causing a computer to convey the at least one parameter relating to Tx/Rx capability to at least one of an Evolved UMTS (Universal Mobile Telecommunications System) Terrestrial Radio Access Network (E-UTRAN), a home location register (HLR), or a mobile switching center (MSC) associated with at least one communication network in the plurality of communication networks.

66. The computer program product of claim 64, wherein the code for causing a computer to determine comprises code for causing a computer to identify a Tx/Rx capability level selected from the group consisting of Tx/Rx capability for a single network at a time, Rx capability for multiple networks simultaneously and Tx capability for a single network at a time, and Tx/Rx capability for multiple networks simultaneously.
